(19) United States
(12) Patent Application Publication
(10) Pub. No.: US 2007/0055047 A1
(43) Pub. Date: Mar. 8, 2007

(54) Molecular weight increase and modification of polycondensates

(76) Inventors: Dirk Simon, Lorrach-Brombach (DE); Rudolf Pfaendner, Rimbach (DE)

Correspondence Address: CIBA SPECIALTY CHEMICALS CORPORATION;PATENT DEPARTMENT, 540 WHITE PLAINS RD, P O BOX 2005, TARRYTOWN, NY, 10591-9005, US

(21) Appl. No.: 10/571,298

(22) PCT Filed: Sep. 15, 2004
(86) PCT No.: PCT/EP04/52171

§ 371 Date: Mar. 10, 2006

(30) Foreign Application Priority Data
Sep. 25, 2003 (EP) 03103559.5

(51) Int. Cl. C08F 6/26

(52) U.S. Cl. 528/487; 528/492

(57) ABSTRACT

The present invention relates to a process for increasing the molecular weight and for the modification of polycondensates, to the use of an additive blend effecting the increase in molecular weight without imparting color to the polycondensates as well as to the polycondensates obtainable by that process. The additive blend contains at least one bis-acyllactam, at least one phosphite, phosphinate or phosphonate; or at least one benzofuran-2-one type compound or at least one phosphite, phosphinate or phosphonate and one benzofuran-2-one type compound.

The present invention relates to a process for increasing the molecular weight and for the modification of polycondensates. Further aspects are the use of an additive blend effecting the increase in molecular weight without imparting color to the polycondensates as well as the polycondensates obtainable by the process.

Polycondensates, for example polyamides, polycarbonates or polyesters, in particular polyethylene terephthalate (PET) and polybutylene terephthalate (PBT) as well as polyester co-polymers and polyester blends e.g. with polycarbonate (PBT/PC), are important thermoplastics belonging to the group of the engineering plastics. Partially crystalline polyesters are used for injection moulding compounds and are distinguished by high strength and rigidity, high dimensional stability and favourable wear characteristics. Amorphous polyesters have high transparency, superior toughness and excellent stress cracking resistance and are processed, for example, to hollow articles. Another field of application of PET is the production of fibres and foils.

The mechanical and physical properties depend essentially on the molecular weight of the polymer. Polycondensates are prepared by condensation in the melt. Average molecular weights can thus be obtained. For some applications, for example drinks packs and technical fibres, higher molecular weights are necessary. These can be obtained by solid phase polycondensation (S. Fakirov, Kunststoffe, 74 (1984), 218 and R. E. Grutzner, A. Koine, Kunststoffe, 82 (1992), 284). The prepolymer is in this case subjected to thermal treatment above the glass transition temperature and below the melt temperature of the polymer under inert gas or under vacuum. However, this method is very time- and energy-consuming. Increasing the intrinsic viscosity requires a residence time of up to 12 hours under vacuum or under inert gas at temperatures from 180 to 240° C.

Another possibility for obtaining higher molecular weights of polycondensates and, in particular, of polyesters is to add a tetracarboxylic acid anhydride and a sterically hindered hydroxyphenylalkylphosphonate to the polycondensate and process the mixture in the melt. This is, for example, described in U.S. Pat. No. 5,693,681.

Furthermore WO 96/34909 and WO 98/47940 disclose the use of bis-acyllactams for increasing the molecular weight of polycondensates, in particular of polyamide. These products, which are, for example, sold by DSM under the trade name Allinco) compensate the hydrolytic/thermal degradation during melt processing of polycondensates. However, these products have a strong influence on the color of the processed polycondensates. In addition the reaction is rather slow and does not ideally fit into typical process cycle times.

It has now been found that the addition of a combination of a bis- acyllactame a phosphite, phospinate or phosphonate and/or a benzofuran-2-one type compound to a polycondensate, with subsequent reactive extrusion of the mixture, allows to substantially increase the molecular weight within short reaction times, without imparting color to the extruded article.

This is of particular interest since the high effort of solid state polycondensation can be avoided. The desired higher molecular weight of the polycondensates can be achieved by applying the instant compositions and processes within a melt processing step (e.g. reactive extrusion), which is much less effort than a solid state polycondensation. Furthermore, the instant process provides the flexibility to the converters to adjust the molecular weight of the polycondensates, according exactly to their needs. Yet another advantage is that the thermal/hydrolytic degradation of polycondensates during melt-processing is prevented or at least significantly reduced.

This is also advantageous in the case of used or thermally or hydrolytically damaged polycondensates, where the damage typically goes hand in hand with a decrease of the molecular weight.

By means of the process of this invention it is possible to increase the molecular weight also in the case of polycondensate recyclates from useful material collections, such as used packages (foils and bottles) and waste textiles. Recyclates can then be used for high-quality recycling, for example in the form of high-performance fibres, injection moulding articles, in extrusion applications or in the form of foams. Such recyclates originate, for example, also from industrial or domestic useful material collections, from production wastes, such as from fibre production and trimmings, or from obligatory retumables, such as bottle collections of PET drinks packs.

In addition, the physicochemical properties are altered through the process of this invention such, that polycondensates can be foamed or extrusion blow moulded into films and containers and other hollow articles.

One aspect of the invention is a process for increasing the molecular weight and/or for the modification of a polycondensate, which process comprises adding to the polycondensate
a) at least one bis-acyllactam;

b1) at least one phosphite, phosphinate or phosphonate; or
b2) at least one benzofuran-2-one type compound or
b3) at least one phosphite, phospinate or phosphonate and one benzofuran-2-one type compound
   and processing the mixture in the melt.

Phosphonates are in general preferred.

In addition to polyester, polyamide or polycarbonate, this invention also embraces the corresponding copolymers and blends, for example PBT/PS, PBT/ASA, PBT/ABS, PBT/PC, PET/ABS, PET/PC, PBT/PET/PC, PBT/PET, PA/PP, PAPE and PANABS. However, it needs to be taken into account that the novel process, like all methods allowing exchange reactions between the components of the blend, may influence the blends, i.e. may result in the formation of copolymeric structures. This can be advantageous as the formed copolymeric structures can improve the compatibility of the blend components.

A preferred process is that wherein the polycondensate is an aliphatic or aromatic polyester, an aliphatic or aromatic polyamide or polycarbonate, or a blend or copolymer thereof.

The polycondensate is for example polyethylene terephthalate (PET), polybutylene therephthalate (PBT), polyethylenenaphthalate (PEN), polytrimethylene terephthalate (PTT), a copolyester, PA 6, PA 6.6, a polycarbonate containing bisphenol A, bisphenol Z or bisphenol F linked via carbonate groups.

Preferred is a process wherein the polycondensate is PET or PBT or a copolymer of PET or PBT.

Polyamides, i.e. both virgin polyamides and polyamide recyclates, are understood to be, for example, aliphatic and aromatic polyamides or copolyamides which are derived from diamines and dicarboxylic acids and/or of aminocarboxylic acid or the corresponding lactams. Suitable polyamides are for example: PA 6, PA 11, PA 12, PA 46, PA 66, PA 69, PA 610, PA 612, PA 10.12, PA 12.12 and also amorphous polyamides and thermoplastc polyamide elastomers such as polyether amides of the Vestamid, Grilamid ELY60, Pebax, Nyim and Grilon ELX type. Polyamides of the cited type are commonly known and are commercially available.

The polyamides used are preferably crystalline or partially crystalline polyamides and, in particular, PA6 and PA6.6 or their blends, as well as recyclates on this basis, or copolymers thereof.

The polyesters, i.e. virgin polyester as well as polyester recyclate, rnay be homopolyesters or copolyesters which are composed of aliphatic, cycloaliphatic or aromatic dicarboxylic acids and diols or hydroxycarboxylic acids.

The polyesters can be prepared by direct esterification (PTA process) and also by transesterification (DMT process). Any of the known catalyst systems may be used for the preparation.

The aliphatic dicarboxylic acids can contain 2 to 40 carbon atoms, the cycloaliphatic dicarboxylic acids 6 to 10 carbon atoms, the aromatic dicarboxylic acids 8 to 14 carbon atoms, the aliphatic hydroxycarboxylic acids 2 to 12 carbon atoms and the aromatic and cycloaliphatic hydroxycarboxylic acids 7 to 14 carbon atoms.

The aliphatic diols can contain 2 to 12 carbon atoms, the cycloaliphatic diol 5 to 8 carbon atoms and the aromatic diols 6 to 16 carbon atoms.

Polyoxyalkylene glycols having molecular weights from 150 to 40000 may also be used.

Aromatic diols are those in which two hydroxyl groups are bound to one or to different aromatic hydrocarbon radicals.

It is also possible that the polyesters are branched with small arnounts, e.g. from 0.1 to 3 mol %, based on the dicarboxylic acids present, of more than difunctional monomers (e.g. pentaerythritol, trimellitic acid, 1,3,5-tri(hydroxyphenyl)benzene, 2,4-dihydroxybenzoic acid or 2-(4-hydroxyphenyl)-2-(2,4-dihydroxyphenyl)propane).

Suitable dicarboxylic acids are linear and branched saturated aliphatic dicarboxylic acids, aromatic dicarboxylic acids and cycloaliphatic dicarboxylic acids.

Suitable aliphatic dicarboxylic acids are those containing 2 to 40 carbon atoms, for example oxalic acid, malonic acid, dimethylmalonic acid, succinic acid, pimelic acid, adipic acid, trimethyladipic acid, sebacic acid, azelaic acid and dimeric acids (dimerisation products of unsaturated aliphatic carboxylic acids such as oleic acid), alkylated malonic and succinic acids such as octadecylsuccinic acid.

Suitable cycloaliphatic dicarboxylic acids are: 1,3-cyclobutanedicarboxylic acid, 1,3-cyclo-pentanedicarboxylic acid, 1,3- and 1,4-cyclohexanedicarboxylic acid, 1,3- and 1,4-(dicarboxylmethyl)cyclohexane, 4,4′-dicyclohexyldicarboxylic acid.

Suitable aromatic dicarboxylic acids are: In particular terephthalic acid, isophthalic acid, ophthalic acid, and 1,3-, 1,4-, 2,6- or 2,7-naphthalenedicarboxylic acid, 4,4′-diphenyidicarboxylic acid, 4,4′-diphenylsulfonedicarboxylic acid, 4,4′-benzophenonedicarboxylic acid, 1,1,3-trimethyl-5-carboxyl-3-(p-carboxylphenyl)indane, 4,4′-diphenyl ether dicarboxylic acid, bis-p-(carboxylphenyl)methane or bis-p-(carboxylphenyl)ethane.

The aromatic dicarboxylic acids are preferred, in particular terephthalic acid, isophthalic acid and 2,6-naphthalenedicarboxylic acid.

Other suitable dicarboxylic acids are those containing -CO-NH-groups; they are described in DE-A2414349. Dicarboxylic acids containing N-heterocyclic rings are also suitable, for example those which are derived from carboxylalkylated, carboxylphenylated or carboxybenzylated monoamine-s-triazinedicarboxylic acids (viz. DE-A-2121184 and 2533675), mono- or bishydantoins, optionally halogenated benzimidazoles or parabanic acid. The carboxyalkyl group can in this case contain 3 to 20 carbon atoms.

Suitable aliphatic diols are the linear and branched aliphatic glycols, in particular those containing 2 to 12, preferably 2 to 6, carbon atoms in the molecule, for example: ethylene glycol, 1,2- and 1,3-propylene glycol, 1,2-, 1,3-, 2,3- or 1,4-butanediol, pentyl glycol, neopentyl glycol, 1,6-hexanediol, 1,12-dodecanediol. A suitable cycloaliphatic diol is e.g. 1,4-dihydroxycyclohexane. Other suitable aliphatic diols are e.g. 1,4-bis(hydroxymethyl)cyclohexane, aromatic-aliphatic diols such as p-xylylene glycol or 2,5-dichloro-p-xylylene glycol, 2,2-(β-hydroxyethoxyphenyl)propane and also polyoxyalkylene glycols such as diethylene glycol, triethylene glycol, polyethylene glycol or polypropylene glycol. The alkylene diols are preferably linear and preferably contain 2 to 4 carbon atoms.

Preferred diols are the alkylenediols, 1,4-dihydroxycyclohexane and 1,4-bis(hydroxymethyl)-cyclohexane. Particularly preferred are ethylene glycol, 1,4-butanediol and 1,2- and 1,3-propylene glycol.

Other suitable aliphatic diols are the β-hydroxyalkylated, in particular —-hydroxyethylated, bisphenols such as 2,2-bis[4′-(β-hydroxyethoxy)phenyl]propane. Other bisphenols will be mentioned later.

Another group of suitable aliphatic diols are the heterocyclic diols described in DE-A-1812003, DE-A-2342432, DE-A-2342372 and DE-A-2453326, for example: N,N′-bis(β-hydroxyethyl)-5,5-dimethylhydantoin, N,N′-bis(β-hydroxypropyl)-5,5-dimethylhydantoin, methylenebis[N-(β-hydroxyethyl)-5-methyl-5-ethylhydantoin], methylenebis[N-(β-hydroxyethyl)-5,5-dimethylhydantoin], N,N′-bis(β-hydroxyethyl)benzimidazolone, N,N′-bis(β-hydroxyethyl)-(tetrachloro)benzimidazolone or N,N′-bis(i-hydroxyethyl)-(tetrabromo)benzimidazolone.

Suitable aromatic diols are mononuclear diphenols and, in particular dinuclear diphenols carrying a hydroxyl group at each aromatic nucleus. Aromatic will be taken to mean preferably hydrocarbonaromatic radicals, such as phenylene or naphthylene. Besides e.g. hydroquinone, resorcinol or 1,5-, 2,6- and 2,7-dihydroxynaphthalene, the bisphenols are to be mentioned in particular, which can be represented by the following formulae:

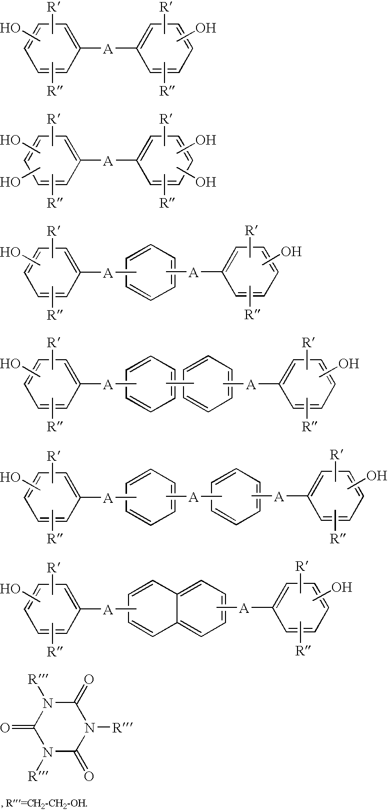

The hydroxyl groups can be in m-position, preferably in p-position, and R′ and R″ in these formulae can be alkyl containing 1 to 6 carbon atoms, halogen, such as chloro or bromo, and, in particular, hydrogen atoms. A may be a direct bond or —O—, —S—, —(O)S(O)—, —C(O)—, —P(O)(C₁-C₂₀alkyl)-, unsubstituted or substituted alkylidene, cycloalkylidene or alkylene.

Examples of unsubstituted or substituted alkylidene are: ethylidene, 1,1- or 2,2-propylidene, 2,2-butylidene, 1,1-isobutylidene, pentylidene, hexylidene, heptylidene, octylidene, dichloroethylidene, trichloroethylidene.

Examples of unsubstituted or substituted alkylene are methylene, ethylene, phenylmethylene, diphenylmethylene, methylphenylmethylene. Examples of cycloalkylidene are cyclopentylidene, cyclohexylidene, cycloheptylidene and cyclooctylidene.

Examples of bisphenols are: bis(p-hydroxyphenyl) ether or bis(p-hydroxyphenyl) thioether, bis(p-hydroxyphenyl)sulfone, bis(p-hydroxyphenyl)methane, bis(4-hydroxyphenylI2,2′-biphenyl, phenylhydroquinone, 1,2-bis(p-hydroxyphenyl)ethane, 1-phenylbis(p-hydroxyphenyl)-ethane, diphenylbis(p-hydroxyphenyl)methane, diphenylbis(p-hydroxyphenyl)ethane, bis(3,5-dimethyl4-hydroxyphenyl)sulfone, bis(3,5-dimethyl-4-hydroxyphenyl)-p-diisopropylbenzene, bis(3,5-dimethyl-4-hydroxyphenyl)-m-diisopropylbenzene 2,2-bis(3′,5′-dimethyl4′-hydroxyphenyl)propane, 1,1- or 2,2-bis(p-hydroxyphenyl)butane, 2,2-bis(p-hydroxyphenyl)hexafluoropropane, 1,1-dichloro- or 1,1,1-trichloro-2,2-bis(p-hydroxyphenyl)ethane, 1,1-bis(p-hydroxyphenyl)cyclopentane and, in particular, 2,2-bis(p-hydroxyphenyl)propane (bisphenol A) and 1,1 -bis(p-hydroxyphenyl)cyclohexane (bisphenol C).

Suitable polyesters of hydroxycarboxylic acids are, for example, polycaprolactone, polypivalolactone or the polyesters of 4-hydroxycyclohexancarboxylic acid, 2-hydroxy-6-naphthalene carboxylic acid or 4-hydroxybenzoic acid.

Other suitable compounds are polymers which may predominantly contain ester bonds or also other bonds, for example polyester amides or polyester imides.

Polyesters containing aromatic dicarboxylic acids have become most important, in particular the polyalkylene terephthalates. Accordingly, those novel moulding compositions are preferred wherein the polyester consists to at least 30 mol %, preferably to at least 40 mol %, of aromatic dicarboxylic acids and to at least 30 mol %, preferably to at least 40 mol %, of alkylenediols containing preferably 2 to 12 carbon atoms, based on the polyester.

In this case the alkylenediol is, in particular, linear and contains 2 to 6 carbon atoms, for example ethylene glycol, tri-, tetra- or hexamethylene glycol and the aromatic dicarboxylic acid, terephthalic acid and/or isophthalic acid.

Particularly suitable polyesters are PET, PBT, PEN, PTT and corresponding copolymers, PET and its copolymer being especially preferred. The process is also particularly important in the case of PET recyclates originating, for example, from bottle collections such as collections of the beverages industry. These materials preferably consist of terephthalic acid, 2,6-naphthalenedicarboxylic acid and/or isophthalic acid in combination with ethylene glycol, diethylene glycol and/or 1,4-bis(hydroxymethyl)cyclohexane.

Polyester blends to be mentioned in particular are those comprising polycarbonate.

Polycarbonate (PC) is understood to mean both virgin polycarbonate and polycarbonate recyclate. PC is obtained, for example, from bisphenol A and phosgene or phosgene analog such as trichloromethylchloroformate, triphosgene or diphenylcarbonate, by condensation in the latter case usually with addition of a suitable transesterification catalyst, for example a boron hydride, an amine, such as 2-methylimidazole or a quaternary ammonium salt; in addition to bisphenol A other bisphenol components may also be used and it is also possible to use halogenated monomers in the benzene nucleus. Particularly suitable bisphenol components to be mentioned are: 2,2-bis(4′-hydroxyphenyl)propane (bisphenol A), 2,4′-dihydroxydiphenylmethane, bis(2-hydroxyphenyl)methane, bis(4-hydroxyphenyl)methane, bis(4-hydroxy-5-propylphenyl)methane, 1,1-bis(4′-hydroxyphenyl)ethane, bis(4-hydro)cyphenyl)-cyclohexylmethane, 2,2-bis(4′-hydroxyphenyly1-phenylpropane, 2,2bis(3′,5′-dirnethyl-4′-hydroxyphenyl)propane, 2,2-bis(3′,5′-dibromo4′-hydroxyphenyl)propane, 2,2-bis(3′,5′-dichloro4′-hydroxyphenyl)propane, 1,1-bis(4′-hydroxyphenyl)cyclododecane, 1,1-bis(3′,5′-dimethyl-4′-hydroxyphenyl)cyclododecane, 1,1-bis(4′-hydroxyphenyl)-3,3,5-trimethylcyclohexane, 1,1-bis(4′-hydroxyphenyl)-3,3,5,5-tetramethylcyclohexane, 1,1 -bis(4′-hydroxyphenyl)-3,3,5-trimethylcyclopentane and the bisphenols mentioned above. The polycarbonates may also be branched by suitable amounts of more than difunctional monomers (examples as indicated above for the polyesters).

The polyester copolymers or blends, which may be used in the novel process are prepared in customary manner from the starting polymers. The polyester component is preferably PET, PBT, and the PC component is preferably a PC based on bisphenol A. The ratio of polyester to PC is preferably from 95:5 to 5:95, a particularly preferred ratio being that in which one component makes up at least 75%.

This invention is also of interest in the case of polyester recyclates, such as are recovered from production wastes, useful material collections or through so-called obligatory returnables e.g. from the beverage packaging industry, automotive industry or from the electronics area. The polycondensate recyclates are in this case in many ways thermally and/or hydrolytically damaged. These recyclates may additionally also contain subordinate amounts of admixtures of plastics of different structure, for example polyolefins, polyurethanes, ABS or PVC. Furthermore, these recyclates may also contain admixtures owing to standard impurities, such as residues of colourants, adhesives, contact media or paints, traces of metal, water, operating agents, or inorganic salts.

The bis-acyllactam is for example of formula Ia or Ib 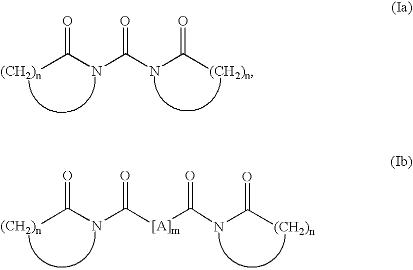
wherein A is C₁-C₁₈alkylen, C₂-C₁₈alkylene interrupted by at least one oxygen atom, C₁-C₁₈alkenylene, phenylene, phenylene-C₁-C₁₈alkylene, C₁-C₁₈alkylene-phenylene, or C₁-C₁₈alkylene-phenylene-C₁-C₁₈alkylene;

m is 0 or 1 and

n is a number from 3 to 12.

These compounds are known and partially items of commerce, for example under the trade name Allinco® from DSM. The compounds, their preparation and use is, for example, described in WO 96/34909 and WO 98/ 47940.

Preferably the phosphonate is of formula II 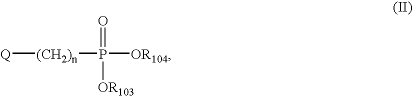
wherein

R₁₀₃ is H, C₁-C₂₀alkyl, unsubstituted or C₁-C₄alkyl-substituted phenyl or naphthyl,

R₁₀₄ is hydrogen, C₁-C20alkyl, unsubstituted or C₁-C₄alkyl-substituted phenyl or naphthyl; or

M^{r+}/ r,

M^{r+} is an r-valent metal cation or the ammonium ion,

n is 0,1,2,3,4, 5or 6, and

r is 1, 2, 3 or 4;

Q is hydrogen, —X—C(O)—OR₁₀₇, or a radical ,

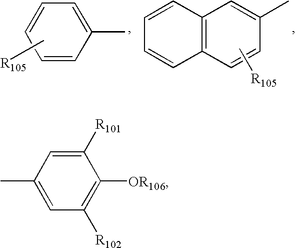

R₁₀₁ is isopropyl, tert-butyl, cyclohexyl, or cyclohexyl which is substituted by 1-3 C₁-C₄alkyl groups,

R₁₀₂ is hydrogen, C₁-C₄alkyl, cyclohexyl, or cyclohexyl which is substituted by 1-3 C₁-C₄alkyl groups,

R₁₀₅ is H, C₁-Cl₈alkyl, OH, halogen or C₃-C₇cycloalkyl;

R₁₀₆ is H, methyl, trimethylsilyl, benzyl, phenyl, sulfonyl or C₁-C₁₈alkyl;

R₁₀₇ is H, C₁-Cloalkyl or C₃-C₇cycloalkyl; and

X is phenylene, C₁-C₄alkyl group-substituted phenylene or cyclohexylene.

Other suitable phosphonates are listed below.

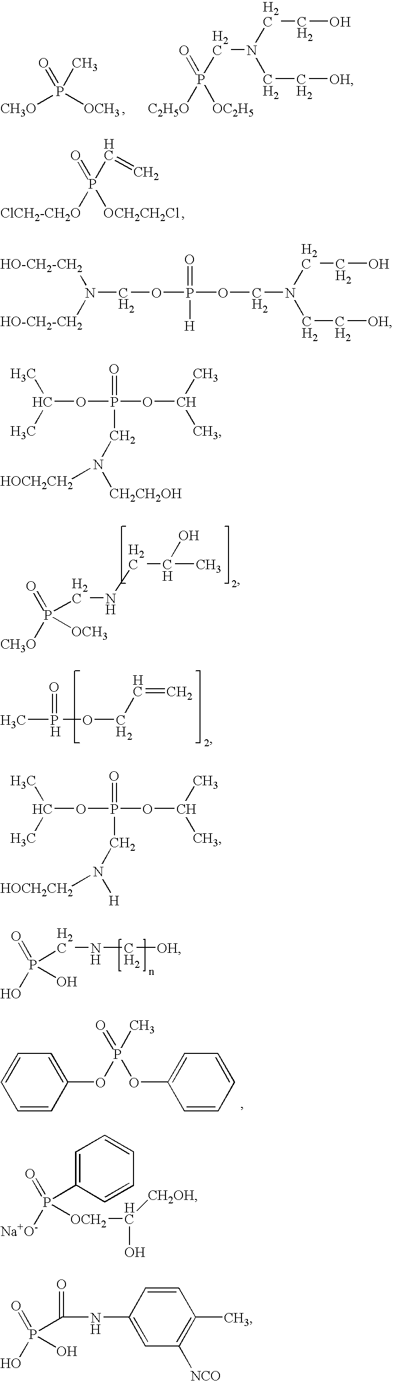

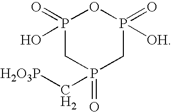

Sterically hindered hydroxyphenylalkylphosphonic acid esters or half-esters, such as those known from U.S. Pat. No. 4 778 840, are preferred.

Halogen is fluoro, chloro, bromo or iodo.

Alkyl substituents containing up to 18 carbon atoms are suitably radicals such as methyl, ethyl, propyl, butyl, pentyl, hexyl and octyl, stearyl and also corresponding branched isomers; C₂-C₄alkyl and isooctyl are preferred.

C₁-C4Alkyl-substituted phenyl or naphthyl which preferably contain 1 to 3, more preferably 1 or 2, alkyl groups is e.g. o-, m- or p-methylphenyl, 2,3-dimethylphenyl, 2,4-dimethylphenyl, 2,5-dimethylphenyl, 2,6-dimethylphenyl, 3,4-dimethylphenyl, 3,5-dimethylphenyl, 2-methyl-6-ethylphenyl, 4-tert-butylphenyl, 2-ethylphenyl, 2,6-diethylphenyl, 1-methylnaphthyl, 2-methyl-naphthyl, 4-methyinaphthyl, 1 ,6-dimethyinaphthyl or 4-tert-butylnaphthyl.

C₁-C4Alkyl-substituted cyclohexyl which preferably contains 1 to 3, more preferably 1 or 2, branched or unbranched alkyl group radicals, is e.g. cyclopentyl, methylcyclopentyl, dimethylcyclopentyl, cyclohexyl, methylcyclohexyl, dimethylcyclohexyl, trimethylcyclohexyl or tertbutylcyclohexyl.

A mono-, di-, tri- or tetra-valent metal cation is preferably an alkali metal, alkaline earth metal, heavy metal or aluminium cation, for example Na⁺, K⁺, Mg⁺⁺, Ca⁺⁺, Ba⁺⁺, Zn⁺⁺, Al⁺⁺⁺, or Ti⁺⁺⁺, Ca⁺⁺ is particularly preferred.

Preferred compounds of formula I are those containing at least one tert-butyl group as R₁ or R₂. Very particularly preferred compounds are those, wherein R₁ and R₂ are at the same time tert-butyl.

n is preferably 1 or 2 and, in particular 1.

For example the phosphonate is of formula IIa 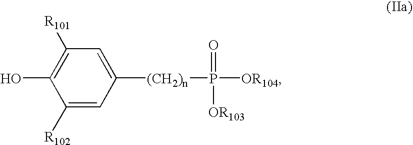
wherein

R₁₀₁ is H, isopropyl, tert-butyl, cyclohexyl, or cyclohexyl which is substituted by 1-3 C₁-C₄alkyl groups,

R₁₀₂ is hydrogen, C₁-C₄alkyl, cyclohexyl, or cyclohexyl which is substituted by 1-3 C₁-C₄alkyl groups,

R₁₀₃ is C₁-C₂₀alkyl, unsubstituted or C₁-C₄alkyl-substituted phenyl or naphthyl,

R104 is hydrogen, C₁-C20alkyl, unsubstituted or C₁-C₄alkyl-substituted phenyl or naphthyl; or M^{r+}/ r;

M^{r+} is an r-valent metal cation, r is 1, 2, 3 or 4; and

n is 1,2,3,4,5 or 6.

Preferably the phosphonate is of formula III, IV, V, VI or VII 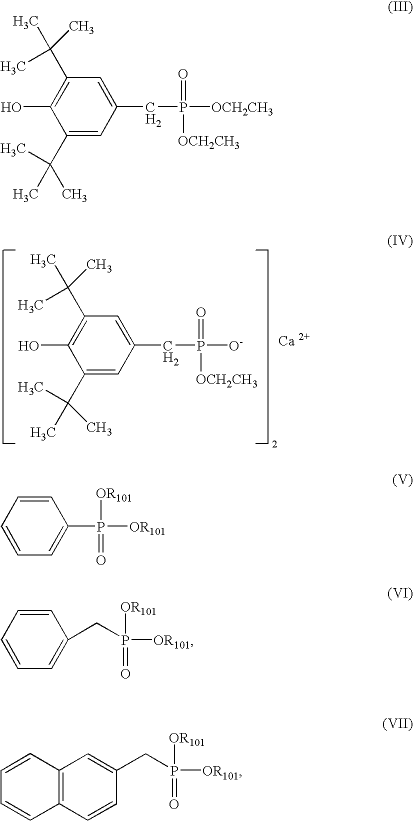
wherein the R₁₀₁ are each independently of one another hydrogen or M^{r+}/ r.

Some of the compounds of formulae II, IIa, III, IV, V, VI, VII and VIII are commercially available or can be prepared by standard processes, as for example described in U.S. Pat. No. 4,778,840.

The phosphinates are of the formula XX 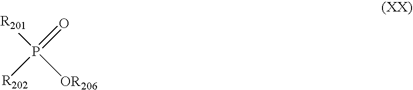
wherein

R₂₀₁ is hydrogen, C₁-C₂₀alkyl, phenyl or C1-C₄alkyl substituted phenyl; biphenyl, naphthyl, —CH₂—O—C₁-C20alkyl or —CH₂—S—C₁-C20alkyl,

R₂₀₂ is C₁-C₂₀alkyl, phenyl or C₁-C₄alkyl substituted phenyl; biphenyl, naphthyl,

—CH₂—O—C₁-C20alkyl or —CH₂—S—C₁-C2oalkyl, or R₁ and R₂ together are a radical of the formula XXI 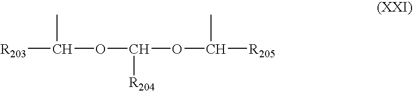
wherein

R₂₀₃, R₂₀₄ and R₂0₅ independently of each other are C₁-C₂₀alkyl, phenyl or C₁-C₄alkyl substituted phenyl;

R₂₀₆ is hydrogen, C₁-C₁₈alkyl or the ion of an alkali metal or the ammonium ion or

R₂₀₆ is a direct bond, which forms together with R₂₀₂ an aliphatic or aromatic cyclic ester.

The alkali metal is for example Na or K.

A specific phosphinate is for example compound 101

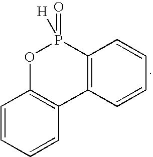

Typical phosphites useful in the instant invention are for example listed below.

For example triphenyl phosphite, diphenyl alkyl phosphites, phenyl dialkyl phosphites, tris(nonylphenyl) phosphite, trilauryl phosphite, trioctadecyl phosphite, distearyl pentaerythritol diphosphite, tris(2,4-di-tert-butylphenyl) phosphite, diisodecyl pentaerythritol diphosphite, bis(2,4-di-tert-butylphenyl) pentaerythritol diphosphite, bis(2,6-di-tert-butyl-4-methylphenyl)pentaerythritol diphosphite, diisodecyloxypentaerythritol diphosphite, bis(2,4-di-tert-butyl-6-methylphenyl)pentaerythritol diphosphite, bis(2,4,6-tris(tert-butyl-phenyl)pentaerythritol diphosphite, tristearyl sorbitol triphosphite, 6-isooctyloxy-2,4,8,10-tetra-tert-butyl-12H-dibenz[d,g]-1,3,2-dioxaphosphocin, bis(2,4-di-tert-butyl-6-methylphenyl) methyl phosphite, bis(2,4-di-tert-butyl-6-methylphenyl) ethyl phosphite, 6-fluoro-2,4,8,10-tetra-tert-butyl-12-methyl-dibenz[d,g]-1,3,2dioxaphosphocin, 2,2′,2″-nitrilo[triethyltris(3,3′,5,5′-tetra-tert-butyl-]1,1′-biphenyl-2,2′-diyl)phosphitel, 2-ethylhexyl(3,3′,5,5′-tetra-tert-butyl-1 ,1′-biphenyl-2,2′-diyl)phosphite, 5-butyl-5-ethyl-2-(2,4,6-tri-tert-butylphenoxy)-1 ,3,2-dioxaphosphirane.

Especially preferred are the following phosphites:

Tris(2,4-di-tert-butylphenyl) phosphite (Irgafoso168, Ciba Specialty Chemicals), tris(nonylphenyl) phosphite,

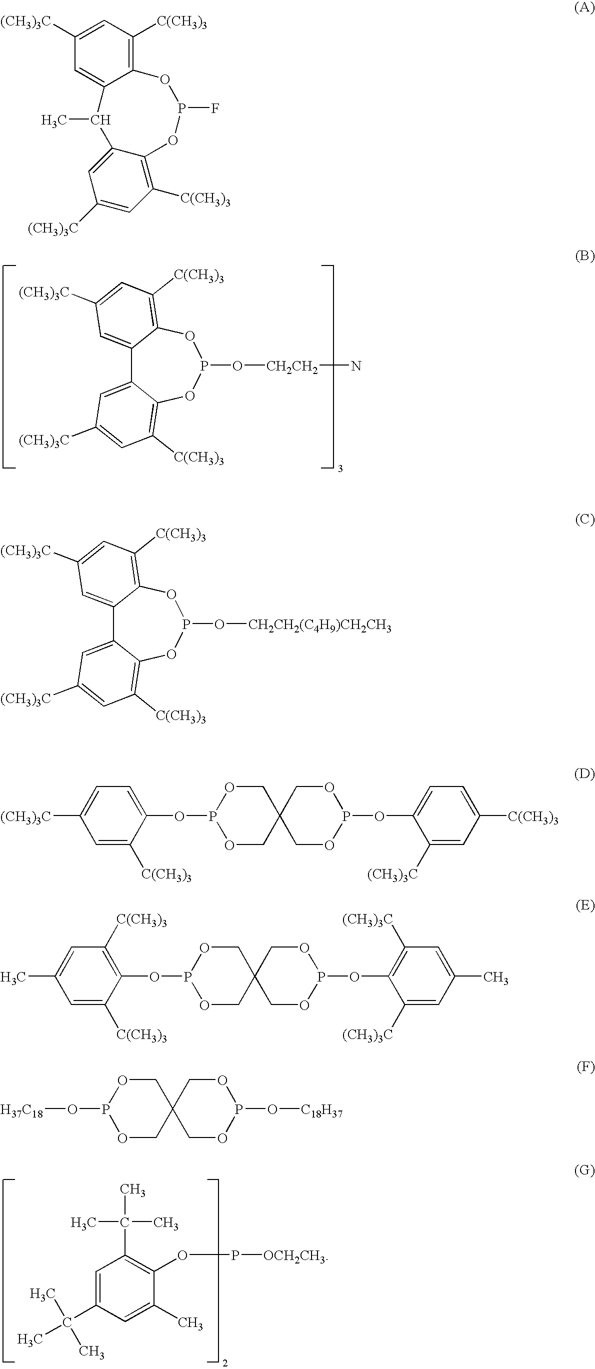

For example the benzofuran-2-one type compound is of formula X 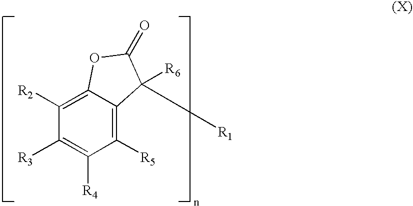
wherein, if n=1,

R₁ is naphthyl, phenanthryl, anthryl, 5,6,7,8-tetrahydro-2-naphthyl, 5,6,7,8-tetrahydro-1-naphthyl, thienyl, benzo[b]thienyl, naphtho[2,3-b]thienyl, thianthrenyl, dibenzofuryl, chromenyl, xanthenyl, phenoxathiinyl, pyrrolyl, imidazolyl, pyrazolyl, pyrazinyl, pyrimidinyl, pyridazinyl, indolizinyl, isoindolyl, indolyl, indazolyl, purinyl, quinolizinyl, isoquinolyl, quinolyl, phthalazinyl, naphthyridinyl. quinoxalinyl, quinazolinyl, cinnolinyl, pteridinyl, carbazolyl, β-car-bolinyl, phenanthridinyl, acridinyl, perimidinyl, phenanthrolinyl, phenazinyl, isothiazolyl, phenothiazinyl, isoxazolyl, furazanyl, biphenyl, terphenyl, fluorenyl or phenoxazinyl, each of which is unsubstituted or substituted by C₁-C₄alkyl, C₁-C₄alkoxy, C₁-C₄alkylthio, hydroxy, halogen, amino, C₁-C₄alkylamino, phenylamino or di(C₁-C₄-alkyl)amino, or R, is a radical of formula XI 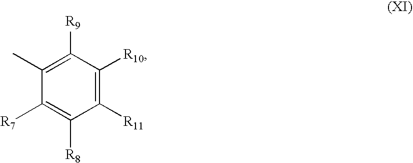
and,

if n=2,

R₁ is unsubstituted or C₁-C₄alkyl- or hydroxy-substituted phenylene or naphthylene; or —R₁₂—X—R₁₃-,

R₂, R₃, R4 and R₅ are each independently of one another hydrogen, chloro, hydroxy, C₁-C₂₅-alkyl, C_{7-C}₉phenylalkyl, unsubstituted or C₁-C₄alkyl-substituted phenyl; unsubstituted or C₁-C₄alkyl-substituted C₅-C₈cycloalkyl; C₁-C,Balkoxy, C₁-Cj₈alkylthio, C₁-C₄alkylamino, di(C₁-C₄-alkyl)amino, C₁-C₂₅alkanoyloxy, C₁-C₂₅alkanoylamino, C₃-C₂₅alkenoyloxy; C₃-C2alkanoyloxy which is interrupted by oxygen, sulfur or 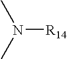
; C₆-C₉cycloalkylcarbonyloxy, benzoyloxy or C₁-C₁₂alkyl-substituted benzoyloxy; or R₂ and R₃, or R₃ and R4, or R4 and R₅, together with the linking carbon atoms, form a benzene ring, R₄ is additionally —(CH₂)p—COR₁₅ or —(CH₂)qOH or, if R₃, R₅ and R₆ are hydrogen, R4 is additionally a radical of formula XlI 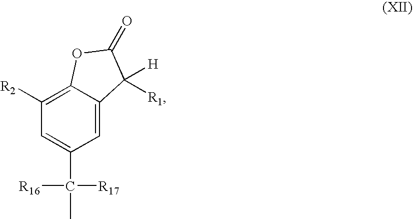
wherein R₁ is as defined above for n =1,

R₆ is hydrogen or a radical of formula XIII

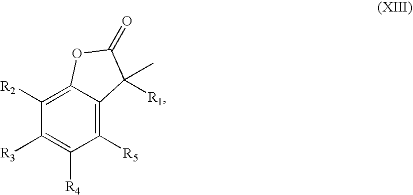

wherein R₄ is not a radical of formula XII, and R₁ is as defined above for n =1,

R₇, R₈, Rg, RI₀ and RI, are each independently of one another hydrogen, halogen, hydroxy, C-C25alkyl; C₂-C₂₅alkyl which is interrupted by oxygen, sulfur or 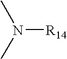
; C₁-C₂₅alkoxy;

C₂-C₂₅alkoxy which is interrupted by oxygen, sulfur or 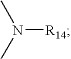
; C₁-C₂₅alkylthio, C₃-C₂₅-alkenyl, C₃-C₂₅alkenyloxy, C₃-C₂₅alkynyl, C₃-C₂₅alkynyloxy, C₇C₉phenylalkyl, C₇C₉phenylalkoxy, unsubstituted or C₁-C₄alkyl-substituted phenyl; unsubstituted or C₁-C₄alkyl-substituted phenoxy; unsubstituted or C₁-C₄alkyl-substituted C₅-C₈cycloalkyl; unsubstituted or C₁-C₄alkyl-substituted C₅-C8cycloalkoxy; C₁-C₄alkylamino, di(C₁-C₄alkyl)amino, C₁-C25alkanoyl; C3-C25alkanoyl which is interrupted by oxygen, sulfur or 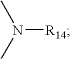
C₁-C₂₅alkanoyloxy; C₃-C₂₅alkanoyloxy which is interrupted by oxygen, sulfur or 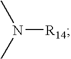
C₁-C₂₅alkanoylamino, C₃-C₅alkenoyl; C₃-C₂₅alkenoyl which is interrupted by oxygen, sulfur or 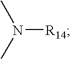
C₃-C₂₅alkenoyloxy; C₃-C25alkenoyloxy which is interrupted by oxygen, sulfur or 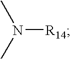
C₆-Cgcycloalkylcarbonyl, C₆-C₉cycloalkylcarbonyloxy, benzoyl or C₁-Cl₂alkyl-substituted benzoyl; benzoyloxy or C₁-Cl₂alkyl-substituted benzoyloxy; 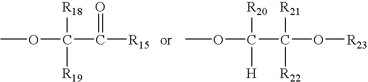
or, in formula II, R₇ and R₈, or R₈ and

R₁₁, together with the linking carbon atoms, form a benzene ring,

R₁₂ and R₁₃ are each independently of the other unsubstituted or C₁-C₄alkyl-substituted phenylene or naphthylene,

R₁₄ is hydrogen or C₁-C₈alkyl,

R₅ is hydroxy,

$$[ - {O}^{-} \frac{1}{r} {M}^{r +} ] ,$$

C₁-C₁₈alkoxy or 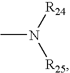
R₁₆ and R₁₇ are each independently of the other hydrogen, CF₃, C₁-Ci₂alkyl or phenyl, or R₁₆ and R₁₇, together with the linking carbon atom, are a C₅-C₈cycloalkylidene ring which is unsubstituted or substituted by 1 to 3 C₁-C₄alkyl;

R₁₈ and R₁₉ are each independently of the other hydrogen, C₁-C₄alkyl or phenyl, R₂₀ is hydrogen or C₁-C₄alkyl,

R₂1 is hydrogen, unsubstituted or C₁-C₄alkyl-substituted phenyl; C₁-C₂₅alkyl; C₂-C₂₅alkyl which is interrupted by oxygen, sulfur or 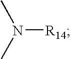
C₇-C₉phenylalkyl which is unsubstituted or substituted at the phenyl moiety by 1 to 3 C₁-C₄alkyl; C₇-C₂₅phenylalkyl which is interrupted by oxygen, sulfur or 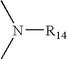
and which is unsubstituted or substituted at the phenyl moiety by 1 to 3 C₁-C₄alkyl, or R₂₀and R₂₁, together with the linking carbon atoms, form a C₅-C₁₂cycloalkylene ring which is unsubstituted or substituted by 1 to 3 C₁-C₄alkyl;

R22 is hydrogen or C₁-C₄alkyl,

R23 is hydrogen, C₁-C₂₅alkanoyl, C₃-C₂₅alkenoyl; C₃-C25alkanoyl which is interrupted by oxygen, sulfur or 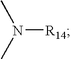
C₂-C₂₅alkanoyl which is substituted by a di(CI-C₆alkyl)phosphonate group; C₆-Cgcycloalkylcarbonyl, thenoyl, furoyl, benzoyl or C₁-Cl₂alkyl-substituted 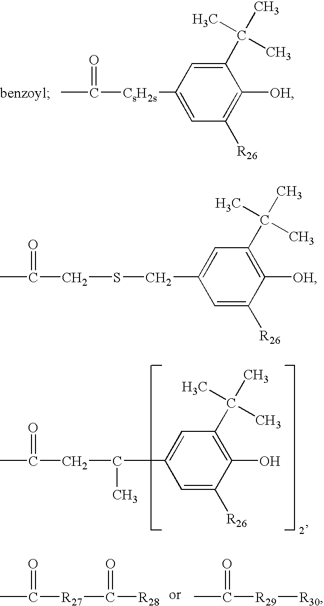
R₂₄ and R₂₅ are each independently of the other hydrogen or C₁-C₁₈alkyl,

R₂₆ is hydrogen or C₁-C₈alkyl,

R₂₇ is a direct bond, C₁-C₁₈alkylene; C₂-C₁₈alkylene which is interrupted by oxygen, sulfur or 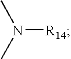
C₂-C₁₈alkenylene, C₂-C₂₀alkylidene, CrC₂₀phenylalkylidene, C₅-C₈cycloalkylene, C₇-C₈bicycloalkylene, unsubstituted or C₁-C₄alkyl-substituted phenylene,

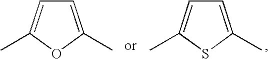

R28is hydroxy

$$[ - {O}^{-} \frac{1}{r} {M}^{r +} ] ,$$

C₁-C₁₈alkoxy or 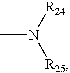
R₂₉ is oxygen, —NH— or

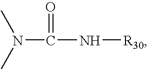

R30 is C₁-C₁₈alkyl or phenyl,

R₃₁ is hydrogen or C₁-C₁₈alkyl,

M is an r-valent metal cation,

X is a direct bond, oxygen, sulfur or —NR₃₁—,

n is 1 or 2,

p is 0, 1 or 2,

q is 1, 2, 3, 4, 5 or 6,

r is 1, 2 or 3,and

s is 0, 1 or 2.

R₁ may be a heterocycle which is naphthyl, phenanthryl, anthryl, 5,6,7,8-tetrahydro-2-naphthyl, 5,6,7,8-tetrahydro-1-naphthyl, thienyl, benzo[b]thienyl, naphtho[2,3-b]thienyl, thianthrenyl, dibenzofuryl, chromenyl, xanthenyl, phenoxathiinyl, pyrrolyl, imidazolyl, pyrazolyl, pyrazinyl, pyrimidinyl, pyridazinyl, indolizinyl, isoindolyl, indolyl, indazolyl, purinyl, quinolizinyl, isoquinolyl, quinolyl, phthalazinyl, naphthyridinyl, quinoxalinyl, quinazolinyl, cinnolinyl, pteridinyl, carbazolyl, ,B-carbolinyl, phenanthridinyl, acridinyl, perimidinyl, phenanthrolinyl, phenazinyl, isothiazolyl, phenothiazinyl, isoxazolyl, furazanyl, biphenyl, terphenyl, fluorenyl or phenoxazinyl, each of which is unsubstituted or substituted by C₁-C₄alkyl, C₁-C₄alkoxy, C₁-C₄alkylthio, hydroxy, halogen, amino, C₁-C₄alkylamino, phenylamino or di(CI-C₄alkyl)amino are, for example, 1 -naphthyl, 2-naphthyl, 1 -phenylamino4-naphthyl, 1-methyinaphthyl, 2-methyinaphthyl, 1-methoxy-2-naphthyl, 2-methoxy-1-naphthyl, 1-dimethylamino-2-naphthyl, 1,2-dimethyl-4-naphthyl, 1,2-dimethyl-6-naphthyl, 1,2-dimethyl-7-naphthyl, 1,3-dimethyl-6-naphthyl, 1,4-dimethyl-6-naphthyl, 1,5-dimethyl-2-naphthyl, 1,6-dimethyl-2-naphthyl, 1-hydroxy-2-naphthyl, 2-hydroxy-1-naphthyl, 1,4-dihydroxy-2-naphthyl, 7-phenanthryl, 1-anthryl, 2-anthryl, 9-anthryl, 3-benzo[b]thienyl, 5-benzo[blthienyl, ]2-benzo[b]thienyl, 4-dibenzofuryl, 4,7-dibenzofuryl, 4-methyl-7-dibenzofuryl, 2-xanthenyl, 8-methyl-2-xanthenyl, 3-xanthenyl, 2-phenoxathiinyl, 2,7-phenoxathiinyl, 2-pyrrolyl, 3-pyrrolyl, 5-methyl-3-pyrrolyl, 2-imidazolyl, 4-imidazolyl, 5-imidazolyl, 2-methyl-4-imidazolyl, 2-ethyl-4-imidazolyl, 2-ethyl-5-imidazolyl, 3-pyrazolyl, 1-methyl-3-pyrazolyl, 1-propyl4-pyrazolyl, 2-pyrazinyl, 5,6-dimethyl-2-pyrazinyl, 2-indolizinyl, 2-methyl-3-isoindolyl, 2-methyl-1-isoindolyl, 1-methyl-2-indolyl, 1-methyl-3-indolyl, 1,5-dimethyl-2-indolyl, 1-methyl-3-indazolyl, 2,7-dimethyl-8-purinyl, 2-methoxy-7-methyl-8-purinyl, 2-quinolizinyl, 3-isoquinolyl, 6-isoquinolyl, 7-isoquinolyl, isoquinolyl, 3-methoxy-6-isoquinolyl, 2-quinolyl, 6-quinolyl, 7-quinolyl, 2-methoxy-3quinolyl, 2-methoxy-6-quinolyl, 6-phthalazinyl, 7-phthalazinyl, 1-methoxy-6-phthalazinyl, 1,4-dimethoxy-6-phthalazinyl, 1,8-naphthyridin-2-yl, 2quinoxalinyl, 6quinoxalinyl, 2,3-dimethyl-6-quinoxalinyl, 2,3-dimethoxy-6-quinoxalinyl, 2-quinazolinyl, 7-quinazolinyl, 2-dimethylamino-6uinazolinyl, 3-cinnolinyl, 6- cinnolinyl, 7-cinnolinyl, 3-methoxy-7-cinnolinyl, 2-pteridinyl, 6-pteridinyl, 7-pteridinyl, 6,7-dimethoxy-2-pteridinyl, 2-carbazolyl, 3-carbazolyl, 9-methyl-2-carbazolyl, 9-methyl-3-carbazolyl, β-carbolin-3-yl, 1-methyl-β-carbolin-3-yl, 1-methyl-β-carbolin-6-yl, 3-phenanthridinyl, 2-acridinyl, 3-acridinyl, 2-perimidinyl, 1-methyl-5-perimidinyl, 5-phenanthrolinyl, 6-phenanthrolinyl, 1-phenazinyl, 2-phenazinyl, 3-isothiazolyl, 4-isothiazolyl, 5-isothiazolyl, 2-phenothiazinyl, 3-phenothiazinyl, 1 0-methyl-3-phenothiazinyl, 3-isoxazolyl, 4-isoxazolyl, 5-isoxazolyl, 4-methyl-3-furazanyl, 2-phenoxazinyl or 10-methyl-2-phenoxazinyl.

Particularly preferred are naphthyl, phenanthryl, anthryl, 5,6,7,8-tetrahydro-2-naphthyl, 5,6,7,8-tetrahydro-1-naphthyl, thienyl, benzo[b]thienyl, naphtho[2,3-b]thienyl, thianthrenyl, dibenzofuryl, chromenyl, xanthenyl, phenoxathiinyl, pyrrolyl, isoindolyl, indolyl, phenothiazinyl, biphenyl, terphenyl, fluorenyl or phenoxazinyl, each of which is unsubstituted or substituted by C₁-C₄alkyl, C₁-C₄alkoxy, C₁-C₄alkylthio, hydroxy, phenylamino or di(C₁-C₄-alkyl)-amino, for example 1-naphthyl, 2-naphthyl, 1-phenylamino-4-naphthyl, 1-methylnaphthyl, 2-methylnaphthyl, 1-methoxy-2-naphthyl, 2-methoxy-1-naphthyl, 1-dimethylamino-2-naphthyl, 1,2-dimethyl4-naphthyl, 1,2-dimethyl-6-naphthyl, 1,2-dimethyl-7-naphthyl, 1,3-dimethyl-6-naphthyl, 1,4-dimethyl-6-naphthyl, 1,5-dimethyl-2-naphthyl, 1,6-dimethyl-2-naphthyl, 1-hydroxy-2-naphthyl, 2-hydroxy-1-naphthyl, 1,4-dihydroxy-2-naphthyl, 7-phenanthryl, 1-anthryl, 2-anthryl, 9-anthryl, 3-benzo[b]thienyl, 5-benzo[b]thienyl, 2-benzo[b]thienyl, 4-dibenzofuryl, 4,7-dibenzofuryl, 4-methyl-7-dibenzofuryl, 2-xanthenyl, 8-methyl-2-xanthenyl, 3-xanthenyl, 2-pyrrolyl, 3-pyrrolyl, 2-phenothiazinyl, 3-phenothiazinyl, 10-methyl-3-phenothiazinyl.

Halogen is typically chloro, bromo or iodo. Chloro is preferred.

Alkanoyl of up to 25 carbon atoms is a branched or unbranched radical, typically formyl, acetyl, propionyl, butanoyl, pentanoyl, hexanoyl, heptanoyl, octanoyl, nonanoyl, decanoyl, undecanoyl, dodecanoyl, tridecanoyl, tetradecanoyl, pentadecanoyl, hexadecanoyl, heptadecanoyl, octadecanoyl, eicosanoyl or docosanoyl. Alkanoyl of 2 to 18, in particular of 2 to 12, e.g. of 2 to 6, carbon atoms is preferred. Acetyl is particularly preferred.

C₂-C₂₅Alkanoyl which is substituted by a di(C₁-C₆alkyl)phosphonate group is typically (CH₃CH₂O)₂POCH₂CO—, (CH₃0)₂POCH₂CO—, (CH₃CH₂CH₂CH₂O)₂POCH₂CO—,
(CH₃CH₂O)₂POCH₂CH₂CO—, (CH₃O)₂POCH₂CH₂CO—, (CH₃CH₂CH₂CH₂O)₂POCH₂CH₂CO—, (CH₃CH₂O)₂PO(CH₂)₄CO—, (CH₃CH₂O)₂PO(CH₂)₈CO— or (CH₃CH₂O)₂PO(CH₂)₁₇CO—.

Alkanoyloxy of up to 25 carbon atoms is a branched or unbranched radical, typically formyloxy, acetoxy, propionyloxy, butanoyloxy, pentanoyloxy, hexanoyloxy, heptanoyloxy, octanoyloxy, nonanoyloxy, decanoyloxy, undecanoyloxy, dodecanoyloxy, tridecanoyloxy, tetradecanoyloxy, pentadecanoyloxy, hexadecanoyloxy, heptadecanoyloxy, octadecanoyloxy, eicosanoyloxy or docosanoyloxy. Alkanoyloxy of 2 to 18, in particular of 2 to 12, e.g. of 2 to 6, carbon atoms is preferred. Acetoxy is particularly preferred.

Alkenoyl of 3 to 25 carbon atoms is a branched or unbranched radical, typically propenoyl, 2-butenoyl, 3-butenoyl, isobutenoyl, n-2,4-pentadienoyl, 3-methyl-2-butenoyl, n-2-octenoyl, n-2-dodecenoyl, isododecenoyl, oleoyl, n-2-octadecenoyl or n-4-octadecenoyl. Alkenoyl of 3 to 18, preferably of 3 to 12, e.g. of 3 to 6, most preferably of 3 to 4, carbon atoms is preferred.

C₃-C25Alkenoyl which is interrupted by oxygen, sulfur or 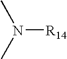
is typically
CH₃0CH₂CH₂CH═CHCO— or CH₃0CH₂CH₂0CH═CHCO—.

Alkenoyloxy of 3 to 25 carbon atoms is a branched or unbranched radical, typically propenoyloxy, 2-butenoyloxy, 3-butenoyloxy, isobutenoyloxy, n-2,4-pentadienoyloxy, 3-methyl-2-butenoyloxy, n-2-octenoyloxy, n-2-dodecenoyloxy, isododecenoyloxy, oleoyloxy, n-2-octadecenoyloxy or n-4-octadecenoyloxy. Alkenoyloxy of 3 to 18, preferably of 3 to 12, e.g. of 3 to 6, most preferably of 3 to 4, carbon atoms is preferred.

C₃-C₂Alkenoyloxy which is interrupted by oxygen, sulfur or 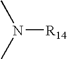
is typically
CH₃OCH₂CH₂CH═CHCOO—or CH₃OCH₂CH₂OCH═CHCOO—.

C₃-C25Alkanoyl which is interrupted by oxygen, sulfur or 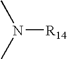
is typically
CH₃—O—CH₂CO—, CH₃—S—CH₂CO—, CH₃—NH—CH₂CO—, CH₃—N(CH₃)—CH₂CO—,
CH₃—O—CH₂CH₂—O—CH₂CO—, CH₃—(O—CH₂CH2—)₂—O—CH₂CO—, CH₃—(O—CH₂CH₂—)₃—O—CH₂CO— or CH₃—(O—CH₂CH₂—)₄—O—CH₂CO—.

C₃-C₂₅Alkanoyloxy which is interrupted by oxygen, sulfur or 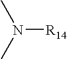
is typically
CH₃—O—CH₂COO—, CH₃—S—CH₂COO—, CH₃—NH—CH₂COO—, CH₃—N(CH₃)—CH₂COO—, CH₃—O—CH₂CH₂—O—CH₂COO—, CH₃—(O—CH₂CH₂—)₂—O—CH₂COO—, CH₃—(O—CH₂CH₂—)₃—O—CH₂COO— or CH₃—(O—CH₂CH₂—)₄—O—CH₂COO—.

C₆-C₉Cycloalkylcarbonyl is typically cyclohexylcarbonyl, cycloheptylcarbonyl or cyclooctylcbonyl. Cyclohexylcarbonyl is preferred.

C₆-C₉Cycloalkylcarbonyloxy is typically cyclohexylcarbonyloxy, cycloheptylcarbonyloxy or cyclooctylcarbonyloxy. Cyclohexylcarbonyloxy is preferred.

C₁-C₁₂Alkyl-substituted benzoyl which preferably carries 1 to 3, more preferably 1 or 2, alkyl groups is typically o-, m- or p-methylbenzoyl, 2,3-dimethylbenzoyl, 2,4-dimethylbenzoyl, 2,5-dimethylbenzoyl, 2,6-dimethylbenzoyl, 3,4-dimethylbenzoyl, 3,5-dimethylbenzoyl, 2-methyl-6-ethylbenzoyl, 4-tert-butylbenzoyl, 2-ethylbenzoyl, 2,4,6-trimethylbenzoyl, 2,6-dimethyl-4-tert-butylbenzoyl or 3,5-di-tert-butylbenzoyl. Preferred substituents are C₁-C₈alkyl, in particular C₁-C₄alkyl.

C₁-Cl₂Alkyl-substituted benzoyloxy which preferably carries 1 to 3, more preferably 1 or 2, alkyl groups is typically o-, m- or p-methylbenzoyloxy, 2,3-dimethylbenzoyloxy, 2,4-dimethyl-benzoyloxy, 2,5-dimethylbenzoyloxy, 2,6-dimethylbenzoyloxy, 3,4-dimethylbenzoyloxy, 3,5-dimethylbenzoyloxy, 2-methyl-6-ethylbenzoyloxy, 4-tert-butylbenzoyloxy, 2-ethylbenzoyloxy, 2,4,6-trimethylbenzoyloxy, 2,6-dimethyl-4-tert-butylbenzoyloxy or 3,5-di-tert-butylbenzoyloxy.

Preferred substituents are C₁-C₈alkyl, in particular C₁-C₄alkyl.

Alkyl of up to 25 carbon atoms is a branched or unbranched radical, such as methyl, ethyl, propyl, isopropyl, n-butyl, sec-butyl, isobutyl, tert-butyl, 2-ethylbutyl, n-pentyl, isopentyl, 1-methylpentyl, 1,3-dimethylbutyl, n-hexyl, 1-methylhexyl, n-heptyl, isoheptyl, 1,1,3,3-tetramethylbutyl, 1-methylheptyl, 3-methylheptyl, n-octyl, 2-ethylhexyl, 1,1,3-trimethylhexyl, 1,1,3,3-tetramethylpentyl, nonyl, decyl, undecyl, 1-methylundecyl, dodecyl, 1,1,3,3,5,5-hexamethylhexyl, tridecyl, tetradecyl, pentadecyl, hexadecyl, heptadecyl, octadecyl, eicosyl or docosyl. One of the preferred meanings of R₂ and R4 is, for example, C₁-C₁₈alkyl. A particularly preferred meaning of R₄ is C₁-C₄alkyl.

Alkenyl of 3 to 25 carbon atoms is a branched or unbranched radical, such as propenyl, 2-butenyl, 3-butenyl, isobutenyl, n-2,4-pentadienyl, 3-methyl-2-butenyl, n-2-octenyl, n-2-dodecenyl, isododecenyl, oleyl, n-2-octadecenyl or n-4-octadecenyl. Alkenyl of 3 to 18, preferably of 3 to 12, e.g. of 3 to 6, in particular of 3 to 4, carbon atoms is preferred.

Alkenyloxy of 3 to 25 carbon atoms is a branched or unbranched radical, such as propenyloxy, 2-butenyloxy, 3-butenyloxy, isobutenyloxy, n-2,4-pentadienyloxy, 3-methyl-2-butenyloxy, n-2-octenyloxy, n-2-dodecenyloxy, isododecenyloxy, oleyloxy, n-2-octadecenyloxy or n-4-octadecenyloxy. Alkenyloxy of 3 to 18, preferably of 3 to 12, e.g. of 3 to 6, in particular of 3 to 4, carbon atoms is preferred.

Alkynyl of 3 to 25 carbon atoms is a branched or unbranched radical, such as propynyl (—CH₂—C≡CH ), 2-butynyl, 3-butynyl, n-2-octynyl, or n-2-dodecynyl. Alkynyl of 3 to 18, preferably of 3 to 12, e.g. of 3 to 6, in particular of 3 to 4 carbon atoms is preferred.

Alkynyloxy of 3 to 25 carbon atoms is a branched or unbranched radical, such propynyloxy (—OCH₂—C≡CH ) 2 -butynyloxy, 3-butynyloxy, n-2-octynyloxy, or n-2-dodecynyloxy.

Alkynyloxy of 3 to 18, preferably of 3 to 12, e.g. of 3 to 6, in particular of 3 to 4, carbon atoms is preferred.

C2-C₂5Alkyl which is interrupted by oxygen, sulfur or 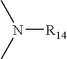
is typically
CH₃—O—CH₂—, CH₃-S—CH₂—, CH₃—NH—CH₂—, CH₃—N(CH₃)—CH₂—, CH₃—O—CH₂CH₂—O—CH₂—, CH₃—(O—CH₂CH2—)₂—O—CH₂—, CH₃—(O—CH₂CH₂—)₃—O—CH₂— or CH₃—(O—CH₂CH₂—)₄—O—CH₂—.

C₇-C₉Phenylalkyl is typically benzyl, a-methylbenzyl, a,a-dimethylbenzyl or 2-phenylethyl. Benzyl and α,α-dimethylbenzyl are preferred.

C₇-C₉Phenylalkyl which is unsubstituted or substituted at the phenyl moiety by 1 to 3 C₁-C₄-alkyl is typically benzyl, a-methylbenzyl, a,a-dimethylbenzyl, 2-phenylethyl, 2-methylbenzyl, 3-methylbenzyl, 4-methylbenzyl, 2,4-dimethylbenzyl, 2,6-dimethylbenzyl or 4-tert-butylbenzyl. Benzyl is preferred.

C₇-C25Phenylalkyl which is interrupted by oxygen, sulfur or 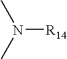
and which is unsubstituted or substituted at the phenyl moiety by 1 to 3 C₁-C₄alkyl is a branched or unbranched radical, such as phenoxymethyl, 2-methylphenoxymethyl, 3-methyl-phenoxymethyl, 4-methylphenoxymethyl, 2,4-dimethylphenoxymethyl, 2,3-dimethylphenoxymethyl, phenylthiomethyl, N-methyl-N-phenyl-methyl, N-ethyl-N-phenylmethyl, 4-tert-butylphenoxymethyl, 4-tert-butylphenoxyethoxymethyl, 2,4-di-tert-butylphenoxymethyl, 2,4-di-tert-butylphenoxyethoxymethyl, phenoxyethoxyethoxyethoxymethyl, benzyloxymethyl, benzyloxyethoxymethyl, N-benzyl-N-ethylmethyl or N-benzyl-N-isopropylmethyl.

C₇-C₉Phenylalkoxy is typically benzyloxy, α-methylbenzyloxy, α,α-dimethylbenzyloxy or 2-phenylethoxy. Benzyloxy is preferred.

C₁-C4Alkyl-substituted phenyl which preferably contains 1 to 3, in particular 1 or 2, alkyl groups is typically o-, m- or p-methylphenyl, 2,3-dimethylphenyl, 2,4-dimethylphenyl, 2,5-dimethylphenyl, 2,6-dimethylphenyl, 3,4-dimethylphenyl, 3,5-dimethylphenyl, 2-methyl-6-ethylphenyl, 4-tert-butylphenyl, 2-ethylphenyl or 2,6-diethylphenyl.

C₁-C4Alkyl-substituted phenoxy which preferably contains 1 to 3, in particular 1 or 2, alkyl groups is typically o-, m- or p-methylphenoxy, 2,3-dimethylphenoxy, 2,4-dimethylphenoxy, 2,5-dimethylphenoxy, 2,6-dimethylphenoxy, 3,4-dimethylphenoxy, 3,5-dimethylphenoxy, 2-methyl-6-ethylphenoxy, 4-tert-butylphenoxy, 2-ethylphenoxy or 2,6-diethylphenoxy.

Unsubstituted or C₁-C₄alkyl-substituted C₅-C₈cycloalkyl is, for example, cyclopentyl, methylcyclopentyl, dimethylcyclopentyl, cyclohexyl, methylcyclohexyl, dimethylcyclohexyl, trimethylcyclohexyl, tert-butylcyclohexyl, cycloheptyl or cyclooctyl. Cyclohexyl and tert-butylcyclohexyl are preferred.

Unsubstituted or C₁-C₄alkyl-substtuted c5C₈cycloalkoxy is, for example, cyclopentoxy, methylcyclopentoxy, dimethylcyclopentoxy, cyclohexoxy, methylcyclohexoxy, dimethylcyclohexoxy, trimethylcyclohexoxy, tert-butylcyclohexoxy, cycloheptoxy or cyclooctoxy. Cyclohexoxy and tert-butylcyclohexoxy are preferred.

Alkoxy of up to 25 carbon atoms is a branched or unbranched radical, such as methoxy, ethoxy, propoxy, isopropoxy, n-butoxy, isobutoxy, pentoxy, isopentoxy, hexoxy, heptoxy, octoxy, decyloxy, tetradecyloxy, hexadecyloxy or octadecyloxy. Alkoxy of 1 to 12, in particular of 1 to 8, e.g. of 1 to 6, carbon atoms is preferred.

C₂-C₂5Alkoxy which is interrupted by oxygen, sulfur or 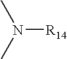
is typically
CH₃—O—CH₂CH_{2—O—, CH}₃—S—CH₂CH_{2—O—, CH}₃—NH—CH₂CH_{2—O—, CH}₃—N(CH₃)—CH₂CH_{2—O—, CH}₃—O—CH₂CH₂—O—CH₂CH_{2—O—, CH}₃—(O—CH₂CH₂—)_{2—O—CH}₂CH_{2—O—, CH}₃—(O—CH₂CH₂—)_{3—O—CH}₂CH₂0- or CH₃—(O—CH₂CH₂—)_{4—O—CH}₂CH₂0—.

Alkylthio of up to 25 carbon-atoms is a branched or unbranched radical, such as methylthio, ethylthio, propylthio, isopropylthio, n-butylthio, isobutylthio, pentylthio, isopentylthio, hexylthio, heptylthio, octylthio, decylthio, tetradecylthio, hexadecylthio or octadecylthio. Alkylthio of 1 to 12, in particular of 1 to 8, e.g. of 1 to 6 carbon atoms is preferred.

Alkylamino of up to 4 carbon atoms is a branched or unbranched radical, such as methylamino, ethylamino, propylamino, isopropylamino, n-butylamino, isobutylamino or tert-butyl-amino.

Di(C₁-C₄alkyl)amino also means that the two radicals are independently of the other branched or unbranched, such as dimethylamino, methylethylamino, diethylamino, methyl-n-propylamino, methylisopropylamino, methyl-n-butylamino, methylisobutylamino, ethylisopropylamino, ethyl-n-butylamino, ethylisobutylamino, ethyl-tert-butylamino, diethylamino, diisopropylamino, isopropyl-n-butylamino, isopropylisobutylamino, di-n-butylamino or di-isobutylamino.

Alkanoylamino of up to 25 carbon atoms is a branched or unbranched radical, such as formylamino, acetylamino, propionylamino, butanoylamino, pentanoylamino, hexanoylamino, heptanoylamino, octanoylamino, nonanoylamino, decanoylamino, undecanoylamino, dodecanoylamino, tridecanoylamino, tetradecanoylamino, pentadecanoylamino, hexadecanoylamino, heptadecanoylamino, octadecanoyamino, eicosanoylamino or docsanoylamino. Alkanoylamino of 2 to 18, in particular of 2 to 12, e.g. of 2 to 6, carbon atoms is preferred.

C₁-Cl₈Alkylene is a branched or unbranched radical, such as methylene, ethylene, propylene, trimethylene, tetramethylene, pentamethylene, hexamethylene, heptamethylene, octamethylene, decamethylene, dodecamethylene or octadecamethylene. C₁-C₁₂Alkylene and, in particular, C₁-C₈alkylene are preferred.

A C₁-C4Alkyl-substituted C₅-C₁₂cycloalkylene ring which preferably contains 1 to 3, in particular 1 or 2, branched or unbranched alkyl groups is typically cyclopentylene, methylcyclopentylene, dimethylcyclopentylene, cyclohexylene, methylcyclohexylene, dimethylcyclohexylene, trimethylcyclohexylene, tert-butylcyclohexylene, cycloheptylene, cyclooctylene or cyclodecylene. Cyclohexylene and tert-butylcyclohexylene are preferred.

C₂-C₁₈Alkylene which is interrupted by oxygen, sulfur or 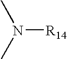
is, for example,
—CH₂—O—CH₂—, —CH₂—S—CH₂—, —CH₂—NH—CH₂—, —CH₂—N(CH₃)—CH₂—, —CH₂—O—CH₂CH2—O—CH₂—, —CH₂—(O—CH₂CH₂—)_{2—O—CH}₂—, —CH₂—(O—CH₂CH₂—)_{3—O—CH}₂—, —CH₂—(O—CH₂CH₂—)_{4—O—CH}₂— or 20 —CH₂CH₂—S—CH₂CH2—.

C₂-C₁₈Alkenylene is typically vinylene, methylvinylene, octenylethylene or dodecenylethylene. C₂-C8Alkenylene is preferred.

Alkylidene of 2 to 20 carbon atoms is, for example, ethylidene, propylidene, butylidene, pentylidene, 4-methylpentylidene, heptylidene, nonylidene, tridecylidene, nonadecylidene, 1-methylethylidene, 1 -ethylpropylidene or 1 -ethylpentylidene. C₂-C8Alkylidene is preferred.

Phenylalkylidene of 7 to 20 carbon atoms is typically benzylidene, 2-phenylethylidene or 1-phenyl-2-hexylidene. C₇C₉Phenylalkylidene is preferred.

C5-C₈Cycloalkylene is a saturated hydrocarbon group having two free valencies and at least one ring unit and is typically cyclopentylene, cyclohexylene, cycloheptylene or cyclooctylene. Cyclohexylene is preferred.

C₇-C₈Bicycloalkylene is typically bicycloheptylene or bicyclooctylene.

Unsubstituted or C₁-C₄alkyl-substituted phenylene or naphthylene is typically 1,2—, 1,3—,1,4-phenylene, 1,2—, 1,3—, 1,4—, 1,6—, 1,7—, 2,6- or 2,7-naphthylene. 1,4-Phenylene is preferred.

A C₁-C4Alkyl-substituted C₅-C₈cycloalkylidene ring which preferably contains 1 to 3, in particular 1 or 2, branched or unbranched alkyl groups is typically cyclopentylidene, methylcyclopentylidene, dimethylcyclopentylidene, cyclohexylidene, methylcyclohexylidene, dimethylcyclohexylidene, trimethylcyclohexylidene, tert-butylcyclohexylidene, cycloheptylidene or cyclooctylidene. Cydohexylidene and tert-butylcyclohexylidene are preferred.

A mono-, di- or tri-valent metal cation is preferably an alkali metal cation, alkaline earth metal cation or aluminium cation, typically Na⁺, K⁺, Mg⁺⁺, Ca⁺⁺ or Al⁺⁺⁺.

Preferably the benzofuran-2-one type compound is of formula XIV 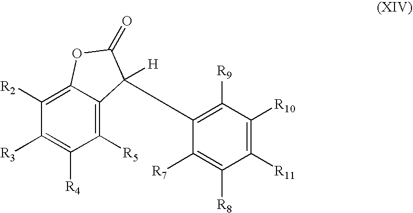
wherein

R₂ is hydrogen or C₁-C₆alkyl,

R₃ is hydrogen,

R4 is hydrogen or C₁-C₆alkyl,

R5 is hydrogen,

R₇, R8, Rg, Rio and R₁₁ are each independently of one another hydrogen, C₁-C₄alkyl, C₁-C₄-alkoxy or 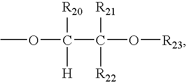
with the proviso that at least two of R₇, R₈, R₉, R₁₀ or

R₁₁ are hydrogen,

R₂₀, R₂₁ and R23 are hydrogen, and

R₂₃ is C₂-C₄alkanoyl.

In particular the benzofuran-2-one type compound is of formula XIVa or XIVb 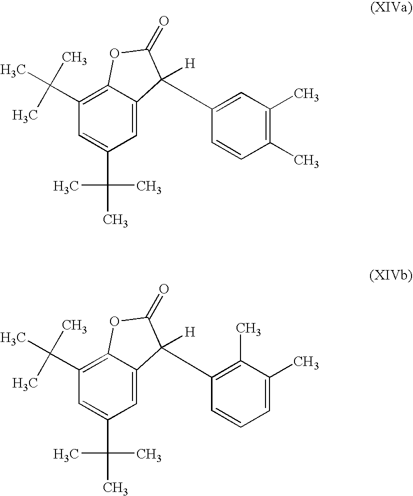
or a mixture or blend of the two compounds of formulae XIVa and XIVb.

The benzofuran-2-one type compounds are known in the literature and partially items of commerce. Their preparation is described, inter alia, in the following U.S. patents: U.S. Pat. No. 4,325,863; U.S. Pat. No. 4,388,244; U.S. Pat. No. 5,175,312; U.S. Pat. No. 5,252,643; U.S. Pat. No. 5,216,052; U.S. Pat. No. 5,369,159; U.S. Pat. No. 5,488,117; U.S. Pat. No. 5,356,966; U.S. Pat. No. 5,367,008; U.S. Pat. No. 5,428,162; U.S. Pat. No. 5,428,177 or U.S. Pat. No. 5,516,920.

Specific commercial examples for a phosphinate is Sanko HCA from Sankyo for phosphonates Irgamod 195 and Irgafos 12 and for phosphites Irgafos 168 from Ciba Specialty Chemicals.

A specific commercial example of a benzofuran-2-one is Irganox HP 136 from Ciba Specialty Chemicals.

Alternatively the benzofuran-2-one type compound is of formula XV 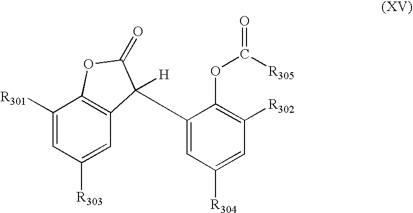
wherein

R301 and R302 are each independently of one another hydrogen or C₁-C₈alkyl,

R303 and R₃₀₄ are each independently of one another C₁-C₁₂alkyl, and

R₃₀₅ is C₁-C₇alkyl.

Of special interest is the compound of the formula XV wherein

R301 and R302 are hydrogen,

R₃₀₃ and R₃₀₄ are tert-octyl, and

R₃₀₅ is methyl.

The synthesis of the compounds of the formula (XV) is, for example, disclosed in EP-A-0 871 066.

For example the bis-acyllactam is used in an amount of 0.01 to 5 %, preferably from 0.1 to 2% by weight based on the weight of the polycondensate.

For instance the phosphite, phosphinate or phosphonate is used in an amount of 0.01 to 5 %, preferably 0.01 to 1% by weight based on the weight of the polycondensate.

Typically the benzofuran-2-one type compound is used in an amount of 0.01 to 5 %, preferably 0.01 to 1% by weight based on the weight of the polycondensate.

For example the sum of the components bis-acyllactam, phosphite, phospinate or phosphonate and benzofuran-2-one is from 0.2 to 10%, preferably from 0.5 to 3% by weight based on the weight of the polycondensate.

The ratio of the bis-acyllactam to the phosphite, phosphinate or phosphonate or the benzofuran-2-one type compound orthe sum of all is typicallyfrom 1:10 to 5:1.

For example the process is carried out in such a way that the maximum mass-temperature of the melt is from 170° to 320° C.

Processing the polycondensate in the melt means heating above the melting point or glass transition temperature usually carried out, with stirring, until the blend is homogeneous. The temperature depends in this case on the polycondensate used. For example:
260 to 290° C. for fibre- and film-grade PET
270 to 310° C. for bottle- and industrial-yarn-grade PET
240 to 290° C. for PBT
170 to 240° C. for amorphous PET-grades
220 to 280° C. for thermoplastic elastomers based on polyesters
280 to 320° C. for PC
270 to 290° C. for PA 6.6
240 to 270° C. for PA 6.

The appropriate processing temperature in dependence on type and grade of polycondensates can be found for example in “Kunststoff Taschenbuch” 21^{th} edition, edited by H. Saechtling, Carl Hanser Verlag 1979.

The incorporation can be carried out in any heatable container equipped with a stirrer, e.g. in a closed apparatus such as a kneader, mixer or stirred vessel. The incorporation is preferably carried out in an extruder or in a kneader. It is immaterial whether processing takes place in an inert atmosphere or in the presence of oxygen.

The addition of the additive or additive blend to the polycondensate can be carried out in all customary mixing machines in which the polycondensate is melted and mixed with the additives. Suitable machines are known to those skilled in the art. They are predominantly mixers, kneaders and extruders.

The process is preferably carried out in an extruder by introducing the additive during processing.

Particularly preferred processing machines are single-screw extruders, contrarotating and corotating twin-screw extruders, planetary-gear extruders, ring extruders or cokneaders. It is also possible to use processing machines provided with at least one gas removal compartment to which a vacuum can be applied.

Suitable extruders and kneaders are described, for example, in Handbuch der Kunststoffextrusion, Vol. 1 Grundlagen, Editors F. Hensen, W Knappe, H. Potente, 1989, pp. 3-7, ISBN:3-446-14339-4 (Vol. 2 Extrusionsanlagen 1986, ISBN 3-446-14329-7).

For example, the screw length is 1-60 screw diameters, preferably 35-48 screw diameters. The rotational speed of the screw is preferably 10-600 rotations per minute (rpm), very particularly preferably 25-300 rpm.

If a plurality of components is added, these can be premixed or added individually.

The additives of the invention and optional further additives can also be added to the polycondensate in the form of a masterbatch (“concentrate”) which contains the components in a concentration of, for example, about 1% to about 40% and preferably 2% to about 20% by weight incorporated in a polycondensate. The polycondensate must not be necessarily of identical structure than the polycondensate where the additives are added finally. In such operations, the polycondensate can be used in the form of powder, granules, solutions, suspensions or in the form of latices.

Incorporation can take place prior to or during the shaping operation, or by applying the dissolved or dispersed compound to the polycondensate, with or without subsequent evaporation of the solvent.

The processing apparatus is preferably a single-screw extruder, twin-screw extruder, planetary-gear extruder, ring extruder or Ko-kneader having optionally one vent zone to which underpressure is applied.

A preferred process is that, which comprises applying low pressure of less than 250 mbar, particularly preferably of less than 100 mbar and, very preferably, of less than 50 mbar, to the vent zone.

Another preferred process is that, wherein the processing apparatus is a closely intermeshing twin-screw extruder or ring extruder with screws rotating in the same direction and with a feed section, a transition section, at least one vent zone and a metering zone, the vent zone being separated from the transition section or from another vent zone by a fusible plug.

This separation via a fusible plug can be effected, for example, by a combination of a kneading element and a return screw element.

The processing apparatus preferably has 14 vent zones, particularly preferably 1-3.

Typical processing times are from 10 seconds to 10 minutes.

When polyesters are processed according to the invention, the intrinsic viscosity (I.V.) of the product after processing is preferably greater than 0.8 and the b* value, which is a measure for yellowing is less than 1.

This invention also relates to a composition comprising
a) a polycondensate;
b) at least one bis-acyllactam;
c1) at least one phosphite, phosphinate or phosphonate; or
c2) at least one benzofuran-2-one type compound or
c3) at least one phosphite, phosphinate or phosphonate and one benzofuran-2-one type compound.

Further aspects of the invention are a polycondensate obtainable by a process as described above and the use of a mixture of
a) at least one bis-acyllactam;
b1) at least one phosphite, phosphinate or phosphonate; or
b2) at least one benzofuran-2-one type compound or
b3) at least one phosphite, phosphinate or phosphonate and one benzofuran-2-one type compound
   for increasing the molecular weight, for the modification and/or for reducing yellowing of a polycondensate.

The definitions and preferences given above for the process apply also to the other aspects of the invention.

Further additives may be present in the polycondensate in addition to the above mentioned novel additive blend. Examples thereof are listed below.

1. Antioxidants

1.1. Alkvlated monophenols,

for example 2,6-di-tert-butyl-4-methylphenol, 2-tert-butyl-4,6-di-methylphenol, 2,6-di-tert-butyl4-ethylphenol, 2,6-di-tert-butyl-4-n-butylphenol, 2,6-di-tert-butyl-4-isobutylphenol, 2,6-dicyclopentyl-4-methylphenol, 2—(a-methylcyclohexyl)-4,6-dimethylphenol, 2,6-dioctadecyl-4-methylphenol, 2,4,6-tricyclohexylphenol, 2,6-di-tert-butyl-4-methoxymethylphenol, nonylphenols which are linear or branched in the side chains, for example 2,6-di-nonyl-4-methylphenol, 2,4-dimethyl-6—(1′-methylundec-1′-yl)phenol, 2,4-dimethyl-6—(1′-methylheptadec-1′-yl)phenol, 2,4-dimethyl-6—(1′-methyltridec-1′-yl)phenol and mixtures thereof.

1.2. Alkylthiomethylphenols,

for example 2,4-dioctylthiomethyl-6-tert-butylphenol, 2,4-dioctylthiomethyl-6-methylphenol, 2,4-dioctylthiomethyl-6-ethylphenol, 2,6-di-dodecylthiomethyl4-nonylphenol.

1.3. Hydroquinones and alkylated hydroquinones,

for example 2,6-di-tert-butyl4-methoxyphenol, 2,5-di-tert-butylhydroquinone, 2,5-di-tert-amylhydroquinone, 2,6-diphenyl-4-octadecyloxyphenol, 2,6-di-tert-butylhydroquinone, 2,5-di-tert-butyl-4-hydroxyanisole, 3,5-di-tert-butyl4-hydroxyanisole, 3,5-di-tert-butyl-4-hydroxyphenyl stearate, bis—(3,5-di-tert-butyl-4-hydroxyphenyl) adipate.

1.4. Tocopherols,

for example α-tocopherol, β-tocopherol, γ-tocopherol, δ-tocopherol and mixtures thereof (Vitamin E).

1.5. Hydroxylated thiodiphenyl ethers,

for example 2,2′-thiobis(6-tert-butyl4-methylphenol), 2,2′-thiobis(4-octylphenol), 4,4′-thiobis(6-tert-butyl-3-methylphenol), 4,4′-thiobis(6-tert-butyl-2-methylphenol), 4,4′-thiobis—(3,6-di-sec-amylphenol), 4,4′-bis(2,6-dimethyl-4-hydroxyphenyl)disulfide.

1.6. Alkylidenebisphenols, for example 2,2′-methylenebis(6-tert-butyl-4-methylphenol), 2,2′-methylenebis(6-tert-butyl-4-ethylphenol), 2,2′-methylenebis[4-methyl-6—(r-methylcyclohexyl)-phenol], 2,2′-methylenebis(4-methyl-6-cyclohexylphenol), 2,2′-methylenebis(6-nonyl-4-methylphenol), 2,2′-methylenebis(4,6-di-tert-butylphenol), 2,2′-ethylidenebis(4,6-di-tert-butylphenol, 2,2′-ethylidenebis(6-tert-butyl4-isobutylphenol), 2,2′-methylenebis[6—(α-methylbenzyl)-4-nonylphenol], 2,2′-methylenebis[6—(α,α-dimethylbenzyl)-4-nonylphenol], 4,4′-methylenebis-(2,6-di-tert-butylphenol), 4,4′-methylenebis(6-tert-butyl-2-methylphenol), 1,1-bis(5-tert-butyl-4-hydroxy-2-methylphenyl)butane, 2,6-bis(3-tert-butyl-5-methyl-2-hydroxybenzyl)-4-methylphenol, 1,1,3-tris(5-tert-butyl-4-hydroxy-2-methylphenyl)butane, 1,1-bis(5-tert-butyl-4-hydroxy-2-methylphenyl)-3-n-dodecylmercaptobutane, ethylene glycol bis[3,3-bis(3′-tert-butyl4′-hydroxyphenyl)butyrate], bis(3-tert-butyl4-hydroxy-5-methyl-phenyl)dicyclopentadiene, bis[2-(3′-tert-butyl-2′-hydroxy-5′-methylbenzyl)-6-tert-butyl-4-methylphenyl]terephthalate, 1,1-bis-(3,5-dimethyl-2-hydroxyphenyl)butane, 2,2-bis—(3,5-di-tert-butyl-4-hydroxyphenyl)propane, 2,2-bis(5-tert-butyl4-hydroxy-2-methylphenyl)-4-n-dodecylmercaptobutane, 1,1,5,5-tetra—(5-tert-butyl-4-hydroxy-2-methylphenyl)pentane.

1.7. O-, N- and S-benzyl compounds,

for example 3,5,3′,5′-tetra-tert-butyl-4,4′-dihydroxydibenzyl ether, octadecyl4-hydroxy-3,5-dimethylbenzylmercaptoacetate, tridecyl-4-hydroxy-3,5-di-tert-butylbenzylmercaptoacetate, tris(3,5-di-tert-butyl-4-hydroxybenzyl)amine, bis(4-tert-butyl-3-hydroxy-2,6-dimethylbenzyl)dithioterephthalate, bis(3,5-di-tert-butyl-4-hydroxy-benzyl)sulfide, isooctyl-3,5-di-tert-butyl-4-hydroxybenzylmercaptoacetate.

1.8. Hydroxybenzylated malonates,

for example dioctadecyl-2,2-bis(3,5-di-tert-butyl-2-hydroxybenzyl)malonate, di-octadecyl-2—(3-tert-butyl-4-hydroxy-5-methylbenzyl)malonate, didodecylmercaptoethyl-2,2-bis—(3,5-di-tert-butyl-4-hydroxybenzyl)malonate, bis[4—(1, 1 ,3,3-tetramethylbutyl)phenyl]-2,2-bis(3,5-di-tert-butyl-4-hydroxybenzyl)malonate.

1.9. Aromatic hydroxybenzyl compounds,

for example 1,3,5-tris(3,5-di-tert-butyl-4-hydroxybenzyl)-2,4,64rimethylbenzene, 1,4-bis(3,5-di-tert-butyl4-hydroxybenzyl)-2,3,5,6-tetramethylbenzene, 2,4,6-tris(3,5-d!iert-butyl-4-hydroxybenzyl)phenol.

1.10. Triazine compounds,

for example 2,4-bis(octylmercapto)-6—(3,5-di-tert-butyl-4-hydroxyanilino)-1,3,5-triazine, 2-octylmercapto-4,6-bis(3,5-di-tert-butyl-4-hydroxyanilino)-1,3,5-triazine, 2-octylmercapto-4,6-bis(3,5-di-tert-butyl-4-hydroxyphenoxy)-1,3,5-triazine, 2,4,6-tris-(3,5-di-tert-butyl-4-hydroxyphenoxy)-1,2,3-triazine, 1,3,5-tris—(3,5-di-tert-butyl-4-hydroxybenzyl)isocyanurate, 1,3,5-tris(4-tert-butyl-3-hydroxy-2,6-dimethylbenzyl)isocyanurate, 2,4,6-tris-(3,5-di-tert-butyl-4-hydroxyphenylethyl)-1,3,5-triazine, 1,3,5-tris(3,5-di-tert-butyl4-hydroxyphenylpropionyl)-hexahydro-1,3,5-triazine, 1,3,5-tris(3,5-dicyclohexyl-4-hydroxybenzyl)iso-cyanurate.

1.11. Acylaminophenols,

for example 4-hydroxylauranilide, 4-hydroxystearanilide, octyl N-(3,5-di-tert-butyl-4-hydroxyphenyl)carbamate.

1.12. Esters of β-(3,5-di-tert-butyl-4-hydroxyphenyl)propionic acid

with mono- or polyhydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl) isocyanurate, N,N′-bis(hydroxyethyl)oxamide, 3-thiaundecanol, 3-thiapentadecanol, trimethylhexanediol, trimethylolpropane, 4-hydroxymethyl-1 -phospha-2,6,7-trioxabicyclo[2.2.2]octane.

1.13. Esters of β-(5-tert-butvl-4-hydroxy-3-methylphenyl)propionic acid

with mono- or polyhydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl) isocyanurate, N,N′-bis-(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.14. Esters of β-(3.5-dicyclohexyl-4-hydroxyphenyl)propionic acid

with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.15. Esters of 3.5-di4ert-butyl-4-hydroxyphenyl acetic acid

with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.16. Amides of β-(3,5-di-ert-butvl4-hydroxvphenvl)Dropionic acid e.g. N,N′-bis(3,5-di-tert-butyl-4-hydroxyphenylpropionyl)hexamethylenediamide, N,N′-bis(3,5-di-tert-butyl-4-hydroxyphenylpropionyl)trimethylenediamide, N,N′-bis(3,5-di-tert-butyl-4-hydroxyphenylpropionyl)-hydrazide, N,N′-bis[2—(3-[3,5-di-tert-butyl-4-hydroxyphenyl]propionyloxy)ethyl]oxamide (Naugard@XL-1 supplied by Uniroyal).

1.17. Ascorbic acid

(vitamin C)

1.18. Aminic antioxidants,

for example N,N′-di-isopropyl-p-phenylenediamine, N,N′-di-sec-butyl-p-phenylenediamine, N,N′-bis(1,4-dimethylpentyl)-p-phenylenediamine, N,N′-bis(1-ethyl-3-methylpentyl)-p-phenylenediamine, N,N′-bis(1-methylheptyl)-p-phenylenediamine, N,N′-dicyclohexyl-p-phenylenediamine, N,N′-diphenyl-p-phenylenediamine, N,N′-bis(2-naphthyl)-p-phenylenediamine, N-isopropyl-N′-phenyl-p-phenylenediamine, N—(1,3-dimethylbutyl)-N′-phenyl-p-phenylenediamine, N—(1-methylheptyl)-N′-phenyl-p-phenylenediamine, N-cyclohexyl-N′-phenyl-p-phenlenediamine, 4—(p-toluenesulfamoyl)diphenylamine, N,N′-dimethyl-N,N′-di-secbutyl-p-phenylenediamine, diphenylamine, N-allyidiphenylamine, 4-isopropoxydiphenylamine, N-phenyl-1 -naphthylamine, N—(4-tert-octylphenyl)-1 -naphthylamine, N-phenyl-2-naphthylamine, octylated diphenylamine, for example p,p′-di-tertoctyldiphenylamine, 4-n-butylaminophenol, 4-butyrylaminophenol, 4-nonanoylaminophenol, 4-dodecanoylaminophenol, 4-octadecanoylaminophenol, bis(4-methoxyphenyl)amine, 2,6-ditert-butyl-4-dimethylaminomethylphenol, 2,4′-diaminodiphenylmethane, 4,4′-diaminodiphenylmethane, N,N,N′,N′-tetramethyl4,4′-diaminodiphenylmethane, 1,2-bis[(2-methylphenyl)amino]ethane, 1,2-bis(phenylamino)propane, (o-tolyl)biguanide, bis[4—(1′,3′-dimethylbutyl)phenyl]amine, tert-octylated N-phenyl-1-naphthylamine, a mixture of mono- and dialkylated tert-butyl/tert-octyidiphenylamines, a mixture of mono- and dialkylated nonyidiphenylamines, a mixture of mono- and dialkylated dodecyidiphenylamines, a mixture of mono- and dialkylated isopropyl/isohexyidiphenylamines, a mixture of mono- und dialkylated tert-butyldiphenylamines, 2,3-dihydro-3,3-dimethyl4H-1,4-benzothiazine, phenothiazine, a mixture of mono- und dialkylated tert-butyl/tert-octylphenothiazines, a mixture of mono- und dialkylated tert-octyl-phenothiazines, N-allylphenothiazin, N,N,N′,N′-tetraphenyl-1,4-diaminobut-2-ene, N,N-bis(2,2,6,6-tetramethyl-piperid-4-yl-hexamethylenediamine, bis(2,2,6,6-tetramethylpiperid-4-yl)sebacate, 2,2,6,6-tetramethylpiperidin-4-one, 2,2,6,6-tetramethylpiperidin-4-ol.

2. UV absorbers and light stabilisers

2.1. 2—(2′-Hydroxyrihenyl)benzotriazoles,

for example 2—(2′-hydroxy-5′-methylphenyl)benzotriazole, 2—(3′,5′-i-tert-butyl-2′-hydroxyphenyl)benzotriazole, 2—(5′-tert-butyl-2′-hydroxyphenyl)benzotriazole, 2—(2′-hydroxy-5′—(1,1,3,3-tetramethylbutyl)phenyl)benzotriazole, 2—(3′,5′-ditert-butyl-2′-hydroxyphenyl)-5-chlorobenzotriazole, 2—(3′-tert-butyl-2′-hydroxy-5′-methylphenyl)-5-chloro-benzotriazole, 2—(3′-sec-butyl-5′-tert-butyl-2′-hydroxyphenyl)benzotriazole, 2—(2′-hydroxy-4′-octyloxyphenyl)benzotriazole, 2—(3′,5′-di-tert-amyl-2′-hydroxyphenyl)benzotriazole, 2—(3′,5′-bis—(α,α-dirmethylbenzyl)-2′-hydroxyphenyl)benzotriazole, 2—(3′-tert-butyl-2′-hydroxy-5′—(2-octyloxycarbonylethyl)phenyl)-5-chlorobenzotriazole, 2—(3′-tert-butyl-5′-[2—(2-ethylhexyloxy)carbonylethyl]-2′-hydroxyphenyl)-5-chlorobenzotriazole, 2—(3′-tert-butyl-2′-hydroxy-5′—(2-methoxycarbonylethyl)phenyl)-5-chlorobenzotriazole, 2—(3′-tert-butyl-2′-hydroxy-5′—(2-methoxycarbonylethyl)phenyl)benzotriazole, 2—(3′-tert-butyl-2′-hydroxy-5′—(2-octyloxycarbonylethyl)phenyl)benzotriazole, 2—(3′-tert-butyl-5′-[2—(2-ethylhexyloxy)carbonylethyl]-2′-hydroxyphenyl)benzotriazole, 2—(3′-dodecyl-2′-hydroxy-5′-methylphenyl)benzotriazole, 2—(3′-tert-butyl-2′-hydroxy-5′—(2-isooctyloxycarbonylethyl)phenylbenzotriazole, 2,2′-methylenebis[4—(1,1,3,3-tetramethylbutyl)-6-benzotriazole-2-ylphenol]; the transesterification product of 2-[3′-tert-butyl-5′—(2-methoxycarbonylethyl)-2′-hydroxyphenyl]-2H-benzotriazole with polyethylene glycol 300; R—CH₂CH₂—COO—CH₂CH₂+ where R =3′-tert-butyl-4′-hydroxy-5′-2H-benzotriazol-2-ylphenyl, 2-[2′-hydroxy-3′—(aca-dimethylbenzyl)-5′—(1,1,3,3-tetramethylbutyl)phenyl]-benzotriazole; 2-[2′-hydroxy-3′—(1, 1 ,3,3-tetramethylbutyl5′—(α,α-dimethylbenzyl)phenyl]benzotriazole.

2.2. 2-Hydroxybenzophenones,

for example the 4-hydroxy, 4-methoxy, 4-octyloxy, 4-decyloxy, 4-dodecyloxy, 4-benzyloxy, 4,2′,4′-trihydroxy and 2′-hydroxy-4,4′-dimethoxy derivatives.

2.3. Esters of substituted and unsubstituted benzoic acids,

as for example 4-tertbutyl-phenyl salicylate, phenyl salicylate, octylphenyl salicylate, dibenzoyl resordnol, bis(4-tert-butylbenzoyl)resorcinol, benzoyl resorcinol, 2,4-di-tert-butylphenyl 3,5-di-tert-butyl-4-hydroxybenzoate, hexadecyl 3,5-di-tert-butyl4-hydroxybenzoate, octadecyl 3,5-di-tert-butyl-4-hydroxybenzoate, 2-methyl-4,6-di-tert-butylphenyl 3,5-i-tert-butyl-4-hydroxybenzoate. 2.4. Acrylates,

for example ethyl α-cyanoβ,β-diphenylacrylate, isooctyl α-cyano-β,β-diphenylacrylate, methyl α-carbomethoxycinnamate, methyl α-cyano-β-methyl-p-methoxycinnamate, butyl α-cyano-β-methyl-p-methoxycinnamate, methyl α-carbomethoxy-p-methoxycinnamate and N—(β-carbomethoxy-o-cyanovinyl)-2-methylindoline.

2.5. Nickel compounds,

for example nickel complexes of 2,2′-thio-bis-[4—(1 ,1,3,3-tetramethylbutyl)phenol], such as the 1:1 or 1:2 complex, with or without additional ligands such as n-butylamine, triethanolamine or N-cyclohexyldiethanolamine, nickel dibutyidithiocarbamate, nickel salts of the monoalkyl esters, e.g. the methyl or ethyl ester, of 4-hydroxy-3,5-di-tertbutylbenzylphosphonic acid, nickel complexes of ketoximes, e.g. of 2-hydroxy-4-methylphenyl undecylketoxime, nickel complexes of 1-phenyl-4-lauroyl-5-hydroxypyrazole, with or without additional ligands.

2.6. Sterically hindered amines,

for example bis(2,2,6,6-tetramethyl-4-piperidyl)sebacate, bis(2,2,6,6-tetramethyl-4-piperidyl)succinate, bis(1,2,2,6,6-pentamethyl-4-piperidyl)sebacate, bis(1 -octyloxy-2,2,6,6-tetramethyl-4-piperidyl)sebacate, bis(1,2,2,6,6-pentamethyl-4-piperidyl) n-butyl-3,5-di-tert-butyl4-hydroxybenzylmalonate, the condensate of 1—(2-hydroxyethyl)-2,2,6,6-tetramethyl-4-hydroxypiperidine and succinic acid, linear or cyclic condensates of N,N′-bis(2,2,6,6-tetramethyl-4-piperidyl)hexamethylenediamine and 4-tert-octylamino-2,6-dichloro-1,3,5-triazine, tris(2,2,6,6-tetramethyl-4-piperidyl)nitrilotriacetate, tetrakis(2,2,6,6-tetramethyl-4-piperidyl)-1,2,3,4-butanetetracarboxylate, 1,1′—(1,2-ethanediyl)-bis(3,3,5,5-tetramethylpiperazinone), 4-benzoyl-2,2,6,6-tetramethylpiperidine, 4-stearyloxy-2,2,6,6-tetramethylpiperidine, bis(1,2,2,6,6-pentamethylpiperidyl)-2-n-butyl-2—(2-hydroxy-3,5-di-tert-butylbenzy)-malonate, 3-n-octyl-7,7,9,9-tetramethyl-1,3,8-triazaspiro[4.5]decane-2,4-dione, bis(1-octyloxy-2,2,6,6-tetramethylpiperidyl)sebacate, bis(1 -octyloxy-2,2,6,6-tetramethylpiperidyl)succinate, linear or cyclic condensates of N,N′-is(2,2,6,6-tetramethyl-4-piperidyl)hexamethylenediamine and 4-morpholino-2,6-dichloro-1,3,5-triazine, the condensate of 2-chloro-4,6-bis(4-nbutylamino-2,2,6,6-etramethylpiperidyl)-1,3,5-triazine and 1,2-bis(3-aminopropylamino)-ethane, the condensate of 2-chloro-4,6-di—(4-n-butylamino-1,2,2,6,6-pentamethylpiperidyl)-1,3,5-triazine and 1,2-bis—(3-aminopropylamino)ethane, 8-acetyl-3-dodecyl-7,7,9,9-tetramethyl-1,3,8-triazaspiro[4.5]decane-2,4-dione, 3-dodecyl-1—(2,2,6,6-tetramethyl-4-piperidyl)pyrrolidin-2,5-dione, 3-dodecyl-1—(1,2,2,6,6-pentamethyl-4-piperidyl)pyrrolidine-2,5-dione, a mixture of 4-hexadecyloxy- and 4-stearyloxy-2,2,6,6-tetramethylpiperidine, a condensation product of N,N′-bis(2,2,6,6-tetramethyl-4-piperidyl)hexamethylenediamine and 4-cyclohexylamino-2,6-dichloro-1,3,5-triazinei a condensation product of 1,2-bis(3-aminopropylamino)ethane and 2,4,6-trichloro-1,3,5-triazine as well as 4-butylamino-2,2,6,6-tetramethylpiperidine (CAS Reg. No. [136504-96-6]); N—(2,2,6,6-tetramethyl-4-piperidyl)-n-dodecylsuccinimid, N-(1,2,2,6,6-pentamethyl4-piperidyl)-n-dodecylsuccinimid, 2-undecyl-7,7,9,9-tetramethyl-1 -oxa-3,8-diaza4-oxo-spiro[4,5]decane, a reaction product of 7,7,9,9-tetramethyl-2-cycloundecyl-1-oxa-3,8-diaza-4-oxospiro [4,5]decane und epichlorohydrin, 1,1-bis(1,2,2,6,6-pentamethyl-4-piperidyloxycarbonyl-2—(4-methoxyphenyl)ethene, N,N′-bis-formyl-N,N′-bis(2,2,6,6-tetramethyl4-piperidyl)hexamethylenediamine, diester of 4-methoxy-methylenemalonic acid with 1,2,2,6,6-pentamethyl4-hydroxypiperidine, poly[methylpropyl-3-oxy4—(2,2,6,6-tetramethyl-4-piperidyl)]siloxane, reaction product of maleic acid anhydride-a-olefin-copolymer with 2,2,6,6-tetramethyl-4-aminopiperidine or 1,2,2,6,6-pentamethyl4-aminopiperidine.

2.7. Oxamides,

for example 4,4′-dioctyloxyoxanilide, 2,2′-diethoxyoxanilide, 2,2′-dioctyloxy-5,5′-di-tert-butoxanilide, 2,2′-didodecyloxy-5,5′-di-tert-butoxanilide, 2-ethoxy-2′-ethyloxanilide, N,N′-bis(3-dimethylaminopropyl)oxamide, 2-ethoxy-5-tert-butyl-2′-ethoxanilide and its mixture with 2-ethoxy-2′-ethyl-5,4′-di-tert-butoxanilide, mixtures of o- and p-methoxy-disubstituted oxanilides and mixtures of o- and p-ethoxy-disubstituted oxanilides.

2.8. 2—(2-Hydroxyphenyl)-1.3.5-triazines,

for example 2,4,6-tris(2-hydroxy-4-octyloxyphenyl) 1,3,5-triazine, 2—(2-hydroxy4-octyloxyphenyl)4,6-bis(2,4-dimethylphenyl)-1,3,5-triazine, 2-(2,4-dihydroxyphenyl)4,6-bis(2,4-dimethylphenyl)-1,3,5-triazine, 2,4-bis(2-hydroxy4-propyloxyphenyl)-6—(2,4-dimethylphenyl)-1,3,5-triazine, 2—(2-hydroxy4-octyloxyphenyl)4,6-bis(4-methylphenyl)-1,3,5-triazine, 2—(2-hydroxy-4odecyloxyphenyl)-4,6-bis(2,4-dimethylphenyl)-1,3,5-triazine, 2—(2-hydroxy-4-tridecyloxyphenyl)4,6-bis(2,4-dimethylphenyl)-1,3,5-triazine, 2-[2-hydroxy-4—(2-hydroxy-3-butyloxy-propoxy)phenyl]-4,6-bis(2,4-dimethyl)-1,3,5-triazine, 2-[2-hydroxy4—(2-hydroxy-3octyloxy-propyloxy)phenyl]-4,6-bis(2,4-dimethyl)-1,3,5-triazine, 2-[4-(dodecyloxy/tridecyloxy-2-hydroxypropoxy)-2-hydroxy-phenyl]4,6-bis(2,4-dimethylphenyl)-1,3,5-triazine, 2-[2-hydroxy4—(2-hydroxy-3-dodecyloxypropoxy)phenyl]-4,6-bis(2,4-dimethyl-phenyl)-1,3,5-triazine, 2—(2-hydroxy4-hexyloxy)phenyl-4,6-diphenyl-1,3,5-triazine, 2—(2-hydroxy-4-methoxyphenyl)4,6-diphenyl-1 ,3,5-triazine, 2,4,6-tris[2-hydroxy4—(3-butoxy-2-hydroxypropoxy)phenyl]-1,3,5-triazine, 2—(2-hydroxyphenyl)-4—(4-methoxyphenyl)-6-phenyl-1,3,5-triazine, 2-2-hydroxy-4-[3—(2-ethylhexyl-1-oxy)-2-hydroxypropyloxy]phenyl)4,6-bis(2,4-dimethylphenyl)-1 ,3,5-riazine.

3. Metal deactivators,

for example N,N′-diphenyloxamide, N-salicylal-N′-salicyloyl hydrazine, N,N′-bis(salicyloyl) hydrazine, N,N′-bis(3,5-di-tert-butyl4-hydroxyphenylpropionyl) hydrazine, 3-salicyloylamino-1,2,4-triazole, bis(benzylidene)oxalyl dihydrazide, oxanilide, isophthaloyl dihydrazide, sebacoyl bisphenylhydrazide, N,N′-diacetyladipoyl dihydrazide, N,N′-bis(salicyloyl)oxalyl dihydrazide, N,N′-bis(salicyloyl)thiopropionyl dihydrazide.

4. Hydroxylamines, for example, N,N-dibenzylhydroxylamine, N,N-diethylhydroxylamine, N,N-dioctylhydroxylamine, N,N-dilaurylhydroxylamine, N,N-ditetradecylhydroxylamine, N,N-dihexadecylhydroxylamine, N,N-dioctadecylhydroxylamine, N-hexadecyl-N-octadecylhydroxylamine, N-heptadecyl-N-octadecylhydroxylamine, N,N-dialkylhydroxylamine derived from hydrogenated tallow amine.

5. Nitrones,

for example, N-benzyl-alpha-phenyinitrone, N-ethyl-alpha-methyinitrone, N-octylalpha-heptylnitrone, N-lauryl-alpha-undecylnitrone, N-tetradecyl-alpha-tridcylnitrone, N-hexadecyl-alpha-pentadecyinitrone, N-octadecyl-alpha-heptadecyinitrone, N-hexadecyl-alpha-heptadecylnitrone, N-ocatadecyl-alpha-pentadecylnitrone, N-heptadecyl-alpha-heptadecylnitrone, N-octadecyl-alpha-hexadecylnitrone, nitrone derived from N,N-dialkylhydroxylamine derived from hydrogenated tallow amine.

6. Thiosynergists,

for example dilauryl thiodipropionate or distearyl thiodipropionate.

7. Peroxide scavengers,

for example esters of β-thiodipropionic acid, for example the lauryl, stearyl, myristyl or tridecyl esters, mercaptobenzimidazole or the zinc salt of 2-mercaptobenzimidazole, zinc dibutyidithiocarbamate, dioctadecyl disulfide, pentaerythritol tetrakis(p-dodecylmercapto)propionate.

8. Polvamide stabilisers,

for example copper salts in combinabon with iodides and/or phosphorus compounds and salts of divalent manganese.

9. Basic co-stabilisers,

for example, melamine, polyvinylpyrrolidone, dicyandiamide, triallyl cyanurate, urea derivatives, hydrazine derivatives, amines, polyamides, polyurethanes, alkali metal salts and alkaline earth metal salts of higher fatty acids, for example calcium stearate, zinc stearate, magnesium behenate, magnesium stearate, sodium ricinoleate and potassium palmitate, antimony pyrocatecholate or zink pyrocatecholate.

10. Nucleating agents,

for example, inorganic substances such as talcum, metal oxides such as titanium dioxide or magnesium oxide, phosphates, carbonates or sulfates of, preferably, alkaline earth metals; organic compounds such as mono- or polycarboxylic acids and the salts thereof, e.g. 4-tert-butylbenzoic acid, adipic acid, diphenylacetic acid, sodium succinate or sodium benzoate; polymeric compounds such as ionic copolymers (ionomers).

11. Fillers and reinforcing agents,

for example calcium carbonate, silicates, glass fibres, glass bulbs, asbestos, talc, kaolin, mica, barium sulfate, metal oxides and hydroxides, carbon black, graphite, wood flour and flours or fibers of other natural products, synthetic fibers.

12. Other additives,

for example, plasticisers, lubricants, emulsifiers, pigments, rheology additives, catalysts, flow control agents, optical brighteners, flameproofing agents, antistatic agents and blowing agents.

Preferred further additives are phenolic antioxidants and UV-absorbers.

Besides the additives mentioned above further functional compounds, in particular from the class of oxazolines can be added.

Polyfunctional, in particular trifunctional, compounds from the class of the oxazolines in the sense of this invention are known and are described, inter alia, in EP-A-0583807 and are, for example, compounds of formula V 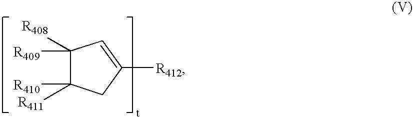
wherein R₄₀₈, R₄₀₉, R410 ,and R₄₁₁ are each independently of one another hydrogen, halogen, C₁-C₂oalkyl, C₄-C₁₅cycloalkyl, unsubstituted or C₁-C₄alkyl-substituted phenyl; C₁-C20alkoxy or C₂-C20carboxyalkyl,

if t=3,

R412 is a trivalent linear, branched or cyclic aliphatic radical containing I to 18 carbon atoms which may be interrupted by oxygen, sulfur or 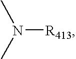
or R₁₂ is also an unsubstituted or C₁-C₄alkyl-substituted benzenetriyl,

if t=2,

R412 is a divalent linear, branched or cyclic aliphatic radical containing 1 to 18 carbon atoms which may be interrupted by oxygen, sulfur or 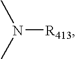
or R412 is also an unsubstituted or C₁-C₄alkyl-substituted phenylene, R₄1₃ is C₁-C₈alkyl, and t is 2 or 3.

Halogen is, for example, fluoro, chloro, bromo or iodo. Chloro is particularly preferred.

Alkyl containing up to 20 carbon atoms is a branched or unbranched radical, for example methyl, ethyl, propyl, isopropyl, n-butyl, sec-butyl, isobutyl, tert-butyl, 2-ethylbutyl, n-pentyl, isopentyl, 1-methylpentyl, 1,3-dimethylbutyl, n-hexyl, 1-methylhexyl, n-heptyl, isoheptyl, 1,1,3,3-tetramethylbutyl, 1-methylheptyl, 3-methylheptyl, n-octyl, 2-ethylhexyl, 1,1,3-trimethylhexyl, 1,1,3,3-tetramethylpentyl, nonyl, decyl, undecyl, 1-methylundecyl, dodecyl, 1,1,3,3,5,5-hexamethylhexyl, tridecyl, tetradecyl, pentadecyl, hexadecyl, heptadecyl, octadecyl, eicosyl or docosyl. A preferred meaning of R8, Rg, R₁₀ and R₁I is C₁-C₁₂alkyl, in particular C₁-C₈alkyl, e.g. C₁-C₄alkyl.

C₄-C₁₅Cycloalkyl, in particular C₅-Ci₂cycloalkyl, is e.g. cyclobutyl, cyclopentyl, cyclohexyl, cycloheptyl, cyclooctyl or cyclododecyl. C₅-C₈Cycloalkyl is preferred, in particular cyclohexyl.

C₁-C4Alkyl-substituted phenyl which preferably contains 1 to 3, more preferably 1 or 2, alkyl groups is, for example, o-, m- or p-methylphenyl, 2,3-dimethylphenyl, 2,4-dimethylphenyl, 2,5-dimethylphenyl, 2,6-dimethylphenyl, 3,4-dimethylphenyl, 3,5-dimethylphenyl, 2-methyl-6-ethylphenyl, 4-tert-butylphenyl, 2-ethylphenyl or 2,6-diethylphenyl.

Alkoxy containing up to 20 carbon atoms is a branched or unbranched radical, for example methoxy, ethoxy, propoxy, isopropoxy, n-butoxy, isobutoxy, pentoxy, isopentoxy, hexoxy, heptoxy, octoxy, decyloxy, tetradecyloxy, hexadecyloxy or octadecyloxy. A preferred meaning of R₄₀₈, R₄₀₉, R₄₁₀ and R₄₁1 is alkoxy containing I to 12, preferably 1 to 8, e.g. 1 to 4, carbon atoms.

Carboxyalkyl containing 2 up to 20 carbon atoms is a branched or unbranched radical, for example carboxymethyl, carboxyethyl, carboxypropyl, carboxybutyl, carboxypentyl, carboxyhexyl, carboxyheptyl, carboxyoctyl, carboxynonyl, carboxydecyl, carboxyundecyl, carboxydodecyl, 2-carboxy-1-propyl, 2-carboxy-1-butyl or 2-carboxy-l-pentyl. A preferred meaning of R8, R₉, R₁₀ and R₁₁ is C₂-Cj₂carboxyalkyl, in particular C₂-C₈carboxyalkyl, e.g. C₂-C₄carboxyalkyl.

A trivalent linear, branched or cyclic aliphatic radical containing 1 to 18 carbon atoms, which radical may be interrupted by oxygen, sulfur or 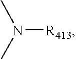
means that the three bonding sites may be at the same atom or at different atoms. Examples thereof are methanetriyl, 1,1,1-ethanetriyl, 1,1,1-propanetriyl, 1,1,1-butanetriyl, 1,1,1-pentanetriyl, 1,1,1-hexanetriyl, 1,1,1-heptanetrnyl, 1,1,1-octanetriyl, 1,1,1-nonanetriyl, 1,1,1-decanetriyl, 1,1,1-undecanetriyl, 1,1,1-dodecanetriyl, 1,2,3-propanetriyl, 1,2,3-butanetriyl, 1,2,3-pentanetriyl, 1,2,3-hexanetriyl, 1,1,3-cyclopentanetriyl, 1,3,5-cyclohexanetriyl, 3-oxo-1,1,5-pentanetriyl, 3-thio-1, 1,5-pentanetriyl or 3-methylamino-1, 1 ,5-pentanetriyl.

A divalent linear, branched or cyclic aliphatic radical containing 1 to 18 carbon atoms, which radical may be interrupted by oxygen, sulfur or 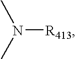
means that the two bonding sites may be at the same atom or at different atoms. Examples thereof are methylene, ethylene, propylene, butylene, pentylene, hexylene, heptylene, octylene, nonylene, decylene, undecylene or dodecylene.

Unsubstituted or C₁-C₄alkyl-substituted benzenetriyl which preferably contains 1 to 3, more preferably 1 or 2, alkyl groups is, for example, 1,2,4-benzenetriyl, 1,3,5-benzenetriyl, 3-methyl-1,2,4-benzoltriyl or 2-methyl-1,3,5-benzenetriyl. 1,2,4-Benzenetriyl and 1,3,5-benzenetriyl are particularly preferred.

Particularly interesting compounds are those of formula V, wherein R₄₀₈, R_{409,} R₄₁₀ and R411 are each independently of one another hydrogen or C₁-C₄alkyl, and R4,2 is 1,2,4-benzenetriyl or 1,3,5-benzenetriyl.

Especially interesting are compounds of formula V, such as 2,2′,2″—(1,3,5-benzoltriyl)-tris-2-oxazoline; 2,2′,2″—(1,2,4-benzoltriyl)-tris-4,4-dimethyl-2-oxazoline; 2,2′,2″—(1,3,5-benzoltriyl)-tris-4,4-dimethyl-2-oxazoline; 2,2′,2″—(1,2,4-benzoltriyl)-tris-5-methyl-2-oxazoline; or 2,2′,2″-(1 ,3,5-benzoltriyl)-tris-5-methyl-2-oxazoline.

Preferred difunctional compounds from the class of the bisoxazolines in the sense of this invention are described by T. Loontjens et al., Makromol. Chem., Macromol. Symp. 75, 211-216 (1993) and are, for example, compounds of formulae

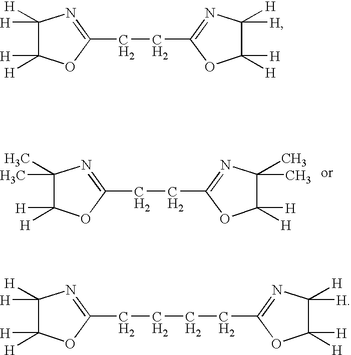

In a specific embodiment the process is carried out with additionally an oxazoline compound.

The following examples illustrate the invention.

Analytical procedures:

Intrinsic Viscosity (I.V.):

1 g polymer is dissolved in 1o0g of a mixture of phenol/di-chloro-benzene (1/1). The viscosity of this solution is measured at 30° C. in an Ubelode-viscosimeter and recalculated to the intrinsic viscosity.

Color:

Color (b* value of the color difference formula) is measured according to ASTM D1925. using a Hunter Lab Scan spectrometer.

Melt Flow Rate (MFR):

MFR is determined within Goettfert MP-P according to ISO 1133.

Materials:

PET: Polyclear T94 from KoSa Gersthofen

Allinco® from DSM (Dodeca hydro-1, ′-carbonyl-bis-azepin-2-one, CAS RN 19494-73-6)

IRGAMOD® 195 (phosphonate from Ciba Specialty Chemicals)

IRGAMODO 295 (phosphonate from Ciba Specialty Chemicals)

IRGAFOS® 12 (phosphite from Ciba Specialty Chemicals)

IRGAFOS® 168 (phosphite from Ciba Specialty Chemicals)

IRGANOX® HP136 (benzofurane-3-one compound from Ciba Specialty Chemicals)

Compound 101 synthesized according to standard procedures

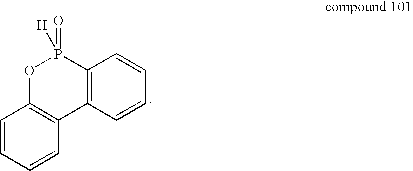

Bis(2,4,4-trimethylpentyl)phosphonic acid CAS 83411-71-6

PET melt processing (extrusion):

General procedure:

In a twin screw extruder (ZSK 25 from Werner & Pfleiderer) with screws rotating in the same direction, the below mentioned formulations are extruded at a temperature of Tₘₐₓ=280° C. (heating zone 1 - 6), a throughput of 5 kg/h and 100 rev/min and pellebsed in a water bath.

5 Comparative Example 2 C0-C2:

The general procedure is applied to a composition of 100% Polyclear T94, 0.1% Irgamod 195 and 0.3% Allinco. The results are given in Table 1.

TABLE 1
Comparative examples

| | | MFR | I.V. | Pellet color |
|---|---|---|---|---|
| | Additive | [g/10 min] | dl/g | B*-value |
| Comp. 0 | Extrusion without additives | 16 | 0.74 | 1.5 |
| Comp. 1 | 0.3% Allinco | 13 | 0.82 | 5.3 |
| Comp. 2 | 0.1% Irgamod 195 | 14 | 0.79 | 2.1 |

Inventive Examples 1 to 5:

The general procedure is repeated with the only difference that the compounds listed in Table 2 are added. The results are given in Table 2.

TABLE 2

| Ex. | | | I.V. | Pellet color |
|---|---|---|---|---|
| No. | Additive | MFR | dl/g | B*-value |
| 1 | 0.3% Allinco + 0.1% Irgamod 195 | 14 | 0.81 | −0.2 |
| 2 | 0.3% Allinco + 0.1% Irgafos 12 | 11 | 0.86 | n.d. |
| 3 | 0.3% Allinco + 0.1% Irgafos 168 | 11 | 0.83 | n.d. |
| 4 | 0.3% Allinco + 0.1% Irganox HP136 | 9.7 | 0.90 | n.d. |
| 5 | 0.3% Allinco + 0.1% compound 101 | 15 | 0.77 | −0.9 |
| 6 | 0.3% Allinco + 0.05% Irgamod | 10 | 0.89 | −0.1 |
| | 295 + 0.05% Irganox HP 136 | | | |
| 7 | 0.3% Allinco + Bis(2,4,4- | n.d. | 0.84 | 0.5 |
| | trimethylpentyl)-phosphonic acid | | | |

n.d.: not determined

Examples with Polycondensates other than PET

Poly(butylene terephthalat) (PBT): Crastin® SK605 NCO10 from DuPont

Poly(butylene terephthalat) / polycarbonate (PBT/PC): Xenoy® CL101 from GE Plastics

Polyamide 6,6: Durethan® A30S from Bayer

Comparative Examples C3-C 1:

The general procedure as described above is applied to the compositions listed in table 3. Subsequently, the material is injection molded to form plaques. The processibility of the extruded polymers and the color of the plaques were assessed by visual rating.

TABLE 3
Comparative examples

| | | | Injection molding | Plaque |
|---|---|---|---|---|
| | Polymer | Additive | processiility | color |
| Comp. 3 | PBT | extrusion without | bad | good |
| | | additives | | |
| Comp. 4 | PBT | 0.3% Allinco | medium | bad |
| Comp. 5 | PBT | 0.1% Irgamod 195 | medium | good |
| Comp. 6 | PBT/PC | Extrusion without | bad | good |
| | | additives | | |
| Comp. 7 | PBT/PC | 0.3% Allinco | medium | bad |
| Comp. 8 | PBT/PC | 0.1% Irgamod 195 | medium | god |
| Comp. 9 | PA6,6 | Extrusion without | bd | god |
| | | additives | | |
| Comp. 10 | PA6,6 | 0.3% Allinco | medium | bd |
| Comp. 11 | PA6,6 | 0.1% Irgamod 195 | medium | god |

Inventive Examples 8 to 10:

The general procedure is repeated with the only difference that the compounds listed in Table 4 are added. Subsequently, the material is injection molded to form plaques. The processibility of the extruded polymer and the color of the plaques were assessed by visual rating.

TABLE 4
Inventive examples

| | | | Injection molding | Plaque |
|---|---|---|---|---|
| Ex. No | Polymer | Additive | processability | color |
| Ex. 8 | PBT | 0.3% Allinco + 0.1% | good | good |
| | | Irgamod 195 | | |
| Ex. 9 | PBT/PC | 0.3% Allinco + 0.1% | good | good |
| | | Irgamod 195 | | |
| Ex. 10 | PA6,6 | 0.3% Allinco + 0.1% | good | good |
| | | Irgamod 195 | | |

1. A process for increasing the molecular weight and/or for the modification of a polycondensate, which process comprises adding to the polycondensate
a) at least one bis-acyllactam and
b1) at least one phosphite, phosphinate or phosphonate; or
b2) at least one benzofuran-2-one type compound or
b3) at least one phosphite, phosphinate or phosphonate and one benzofuran-2-one type compound and
processing the mixture in the melt.

2. A process according to claim I wherein the polycondensate is an aliphatic or aromatic polyester, an aliphatic or aromatic polyamide or polycarbonate or a blend or copolymer thereof.

3. A process according to claim 1 wherein the polycondensate is polyethylene therephthalate (PET), polybutylene therephthalate (PBT), polyethylenenaphthenate (PEN), a copolyester, PA 6, PA 6,6or a polycarbonate containing bisphenol A, bisphenol Z or bisphenol F linked via carbonate groups.

4. A process according to claim 1 wherein the polycondensate is PET or PBT or a copolymer of PET or PBT.

5. A process according to claim 1 wherein the bis-acyllactam is of formula Ia or Ib 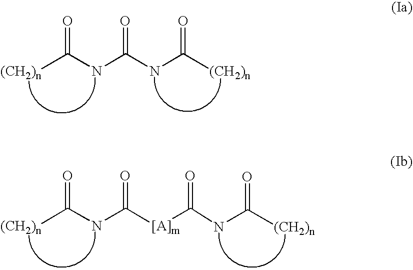
wherein A is C₁-C₁₈alkylene, C₂-C₁₈alkylene interrupted by at least one oxygen atom,
C₁-C₁₈alkenylene, phenylene, phenylene-C₁-C₁₈alkylene, C₁-C₁₈alkylene-phenylene or
C₁-C₁₈alkylene-phenylene-C₁-C₁₈alkylene;
m is 0 or 1 and
n is a number from 3 to 12.

6. A process according to claim 1 wherein the phosphonate is of formula II 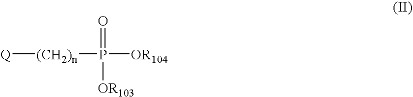
wherein
R₁₀₃ is H, C₁-C₂₀alkyl or unsubstituted or C₁-C₄alkyl-substituted phenyl or naphthyl,
R₁₀₄ is hydrogen, C₁-C₂₀alkyl or unsubstituted or C₁-C₄alkyl-substituted phenyl or naphthyl;
or is M^{r+}/ r,
M^{r+} is an r-valent metal cation or the ammonium ion,
n is 0, 1, 2, 3, 4, 5 or 6and
r is 1, 2, 3 or 4;
Q is hydrogen, —X—C(O)—OR,07or a radical 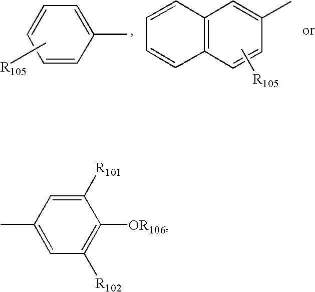
R₁₀₁ is isopropyl, tert-butyl, cyclohexyl, or cyclohexyl which is substituted by 1-3 C₁-C₄alkyl groups,
R₁₀₂ is hydrogen, C₁-C₄alkyl, cyclohexyl, or cyclohexyl which is substituted by 1-3 C₁-C₄alkyl groups,
R₁₀₅ is H, C₁-C₁₈alkyl, OH, halogen or C₃-C₇cycloalkyl;
R₁₀₆ is H, methyl, trimethylsilyl, benzyl, phenyl, sulfonyl or C₁-C₁₈alkyl;
R₁₀₇ is H, C₁-Cloalkyl or C₃-C₇cycloalkyl and
X is phenylene, C₁-C₄alkyl group-substituted phenylene or cyclohexylene.

7. A process according to claim 6 wherein the phosphonate is of formula IIa 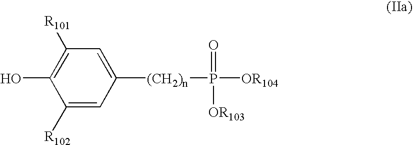
wherein
R₁₀₁ is H, isopropyl, tert-butyl, cyclohexyl, or cyclohexyl which is substituted by 1-3 C₁-C₄alkyl groups,
R₁₀₂ is hydrogen, C₁-C₄alkyl, cyclohexyl, or cyclohexyl which is substituted by 1-3 C₁-C₄alkyl groups,
R₁₀₃ is C,-C₂₀alkyl or unsubstituted or C,-C₄alkyl-substituted phenyl or naphthyl,
R₁₀₄ is hydrogen, C₁-C₂₀alkyl or unsubstituted or C₁-C₄alkyl-substituted phenyl or naphthyl;
or is M^{r+}/ r;
M^{r+} is an r-valent metal cation,
r is 1, 2, 3 or 4and
n is 1,2,3,4,5 or 6.

8. A process according to claim 6 wherein the phosphonate is of formula III, IV, V, VI or VII 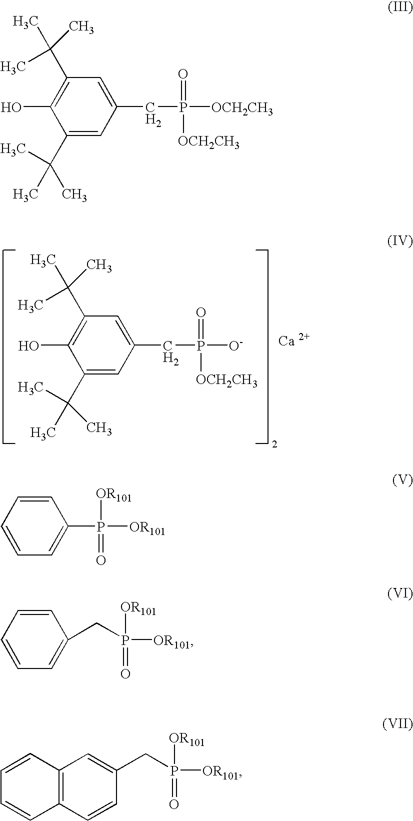
wherein the R₁₀₁ are each independently of one another hydrogen or M^{r+}/r. - 5 - PP/1-22950/CGM 533/PCT

9. A process according to claim 1 wherein the phosphinates are of the formula XX 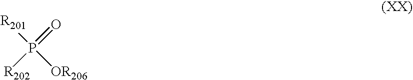
wherein
R₂₀₁ is hydrogen, C₁-C₂₀alkyl, phenyl or C₁-C₄alkyl substituted phenyl; biphenyl, naphthyl, —CH₂—O-C₁-C₂₀alkyl or —CH₂—S-C₁-C₂₀alkyl,
R₂₀₂ is C₁-C₂₀alkyl, phenyl or C₁-C₄alkyl substituted phenyl; biphenyl, naphthyl, —CH₂-0-C₁-C₂₀alkyl or —CH₂—S-C₁-C₂₀alkyl, or together are a radical of the formula XXI 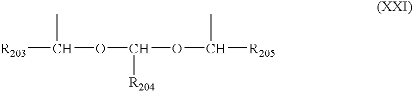
wherein
R₂₀₃, R₂₀₄ and R₂₀₅ independently of each other are C₁-C₂₀alkyl, phenyl or C₁-C₄alkyl substituted phenyl; and
R₂₀₆ is hydrogen, C₁-C₁₈alkyl or the ion of an alkali metal or the ammonium ion or
R₂₀₆ is a direct bond, which forms together with R₂₀₂ an aliphatic or aromatic cyclic ester.

10. A process according to claim 1 wherein the benzofuran-2-one type compound is of formula X 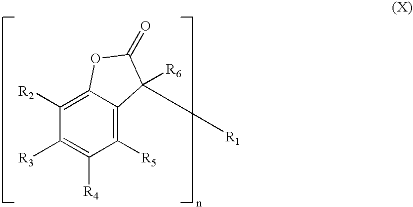
wherein, if n =1,
R₁ is naphthyl, phenanthryl, anthryl, 5,6,7,8-tetrahydro-2-naphthyl, 5,6,7,8-tetrahydro-1-naphthyl, thienyl, benzo[b]thienyl, naphtho[2,3-b]thienyl, thianthrenyl, dibenzofuryl, chromenyl, xanthenyl, phenoxathiinyl, pyrrolyl, imidazolyl, pyrazolyl, pyrazinyl, pyrimidinyl, pyridazinyl, indolizinyl, isoindolyl, indolyl, indazolyl, purinyl, quinolizinyl, isoquinolyl, quinolyl, phthalazinyl, naphthyridinyl, quinoxalinyl, quinazolinyl, cinnolinyl, pteridinyl, carbazolyl, -carbolinyl, phenanthridinyl, acridinyl, perimidinyl, phenanthrolinyl, phenazinyl, isothiazolyl, phenothiazinyl, isoxazolyl, furazanyl, biphenyl, terphenyl, fluorenyl or phenoxazinyl, each of which is unsubstituted or substituted by C₁-C₄alkyl, C₁-C₄alkoxy, C₁-C₄alkylthio, hydroxy, halogen, amino, C₁-C₄alkylamino, phenylamino or di(C₁-C₄-alkyl)amino, or R₁ is a radical of formula XI 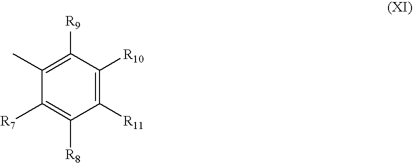
and
if n =2,
R₁ is unsubstituted or C₁-C₄alkyl- or hydroxy-substituted phenylene or naphthylene; or —R₁₂—X—R₁₃—
R₂, R₃, R4 and R₅ are each independently of one another hydrogen, chloro, hydroxy, C₁-C₂₅-alkyl, C₇-C₉phenylalkyl, unsubstituted or C₁-C₄alkyl-substituted phenyl; unsubstituted or C₁-C₄alkylsubstituted C₅-C₈cycloalkyl; C₁-C₁₈alkoxy, C₁-C₁₈alkylthio, C₁-C₄alkylamino, di(C₁-C₄-alkyl)amino, C₁-C₂₅ alkanoyloxy, C₁-C₂₅alkanoylamino, C₃-C₂₅alkenoyloxy; C₃-C₂₅alkanoyloxy which is interrupted by oxygen, sulfur or 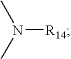
C₆-Cgcycloalkylcarbonyloxy, benzoyloxy or C₁-C₁₂alkyl-substituted benzoyloxy; or R₂ and R₃, or R₃ and R4, or R4 and R₅, together with the linking carbon atoms, form a benzene ring, R4 is additionally —(CH₂)p-COR₁₅ or —(CH₂)qOH or, if R₃, R₅ and R6 are hydrogen, R4 is additionally a radical of formula XII 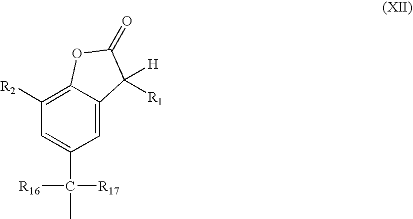
wherein R₁ is as defined above for n =1,
R6 is hydrogen or a radical of formula XIII 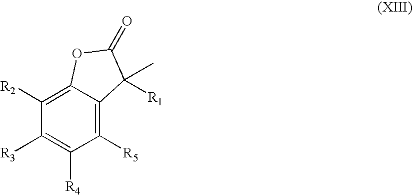
wherein R4 is not a radical of formula Xll[[,]] and R₁ is as defined above for n =1,
R₇, RP, Rg, R₁₀ and R₁₁ are each independently of one another hydrogen, halogen, hydroxy, C₁-C₂₅alkyl; C₂-C₂₅alkyl which is interrupted by oxygen, sulfur or 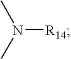
C₁-C₂₅alkoxy; C₂-C₂₅alkoxy which is interrupted by oxygen, sulfur or 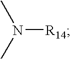
C₁-C₂₅alkylthio, C₃-C₂₅-alkenyl,
C₃-C₂₅alkenyloxy, C₃-C₂₅alkynyl, C₃-C₂₅alkynyloxy, C₇-C₉phenylalkyl, C₇-C₉phenylalkoxy, unsubstituted or C₁-C₄alkyl-substituted phenyl; unsubstituted or C₁-C₄alkyl-substituted phenoxy; unsubstituted or C₁-C₄alkyl-substituted C₅-C₈cycloalkyl; unsubstituted or C₁-C₄alkyl-substituted C₅-C₈cycloalkoxy; C₁-C₄alkylamino, di(C₁-C₄alkyl)amino, C₁-C₂₅alkanoyl; C₃-C₂₅alkanoyl which is interrupted by oxygen, sulfur or 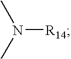
C₁-C₂₅alkanoyloxy; C₃-C₂₅alkanoyloxy which is interrupted by oxygen, sulfur or 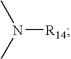
C₁-C₂₅alkanoylamino, C₃-C₂₅alkenoyl; C₃-C₂₅alkenoyl which is interrupted by oxygen, sulfur or 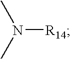
C₃-C₂₅alkenoyloxy; C₃-C₂₅alkenoyloxy which is interrupted by oxygen, sulfur or 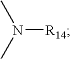
C₆-Cgcycloalkylcarbonyl, C₆-Cgcycloalkylcarbonyloxy, benzoyl or C₁-C₁₂alkyl-substituted benzoyl; benzoyloxy or C₁-C₁₂alkyl-substituted benzoyloxy; 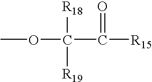
or 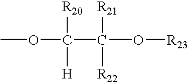
or, in formula II, R₇ and R8, or R8 and R₁₁, together with the linking carbon atoms, form a benzene ring,
R₁₂ and R₁₃ are each independently of the other unsubstituted or C₁-C₄alkyl-substituted phenylene or naphthylene,
R₁₄ is hydrogen or C₁-C₈alkyl,
R₁₅is hydroxy,
$$[ - {O}^{-} \frac{1}{r} {M}^{r +} ] ,$$
C₁-C₁₈alkoxy or 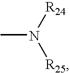
R₁₆ and R₁₇ are each independently of the other hydrogen, CF₃, C₁-C₁₂alkyl or phenyl, or R₁₆ and R₁₇, together with the linking carbon atom, are a C₅-C₈cycloalkylidene ring which is unsubstituted or substituted by 1 to 3 C₁-C₄alkyl;
R₁₈ and Rlg are each independently of the other hydrogen, C₁-C₄alkyl or phenyl,
R₂₀ is hydrogen or C₁-C₄alkyl,
R₂₁ is hydrogen, unsubstituted or C,-C₄alkyl-substituted phenyl; C,-C₂₅alkyl; C₂-C₂₅alkyl which is interrupted by oxygen, sulfur or 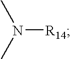
C₇-C₉phenylalkyl which is unsubstituted or substituted at the phenyl moiety by 1 to 3 C₁-C₄alkyl; C₇-C₂₅phenylalkyl which is interrupted by oxygen, sulfur or 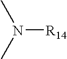
and which is unsubstituted or substituted at the phenyl moiety by 1 to 3 C₁-C₄alkyl, or R₂₀ and R₂₁, together with the linking carbon atoms, form a C₅-C₁₂cycloalkylene ring which is unsubstituted or substituted by 1 to 3 C₁-C₄alkyl;
R₂₂ is hydrogen or C₁-C₄alkyl,
R₂₃ is hydrogen, C₁-C₂₅alkanoyl, C₃-C₂₅alkenoyl; C₃-C₂₅alkanoyl which is interrupted by oxygen, sulfur or 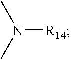
C₂-C₂₅alkanoyl which is substituted by a di(C₁-C₆alkyl)phosphonate group; C₆-Cgcycloalkylcarbonyl, thenoyl, furoyl, benzoyl or C₁-C₁₂alkyl-substituted benzoyl; 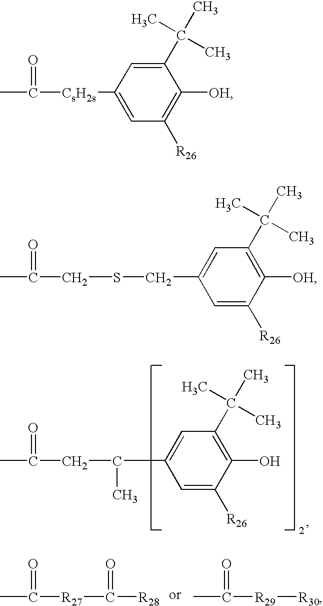
R₂₄ and R₂₅ are each independently of the other hydrogen or C₁-C₁₈alkyl,
R₂₆ is hydrogen or C₁-C₈alkyl,
R₂₇ is a direct bond, C₁-C₁₈alkylene; C₂-C₁₈alkylene which is interrupted by oxygen, sulfur or 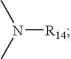
C₂-C₁₈alkenylene, C₂-C₂₀alkylidene, C₇-C₂₀phenylalkylidene, C₅-C₈cycloalkylene, C₇-C₈bicycloalkylene, unsubstituted or C₁-C₄alkyl-substituted phenylene, 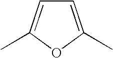
or 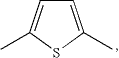
R₂₈ is hydroxy,
$$[ - {O}^{-} \frac{1}{r} {M}^{r +} ] ,$$
C₁-C₁₈alkoxy or 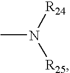
R29 is oxygen, —NH— or 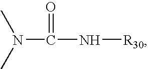
R₃₀ is C₁-C₁₈alkyl or phenyl,
R₃₁ is hydrogen or C₁-C₁₈alkyl,
M is an r-valent metal cation,
X is a direct bond, oxygen, sulfur or —NR₃₁—,
n is 1 or 2,
p is 0, 1 or 2,
q is 1, 2, 3, 4, 5 or 6,
r is 1, 2 or 3and
s is 0, 1 or 2.

11. A process according to claim 10 wherein the benzofuran-2-one type compound is of formula XIV 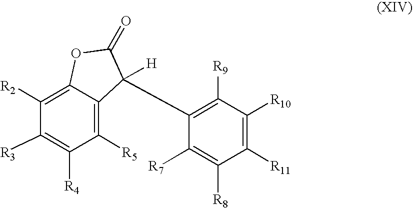
wherein
R₂ is hydrogen or C₁-C₆alkyl,
R₃ is hydrogen,
R4 is hydrogen or C₁-C₆alkyl,
R₅ is hydrogen,
R₇, R₈, R₉, R₁₀ and R₁₁ are each independently of one another hydrogen, C₁-C₄alkyl, C₁-C₄-alkoxy or 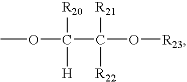
with the proviso that at least two of R₇, R8, Rg, R₁₀ or R., are hydrogen,
R₂₀, R₂, and R₂₃ are hydrogen and
R₂₃ is C₂-C₄alkanoyl.

12. A process according to claim 11 wherein the benzofuran-2-one type compound is of formula XIVa or XIVb 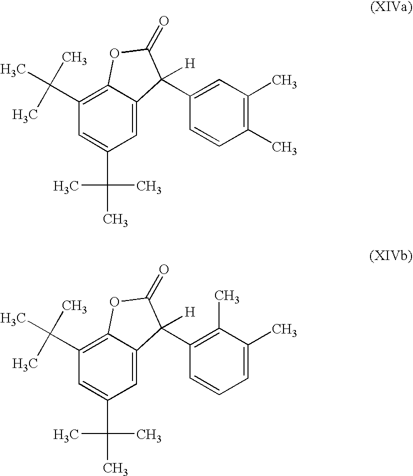
or a mixture or blend of the two compounds of formulae XIVa and XlVb.

13. A process according to claim 1 wherein the benzofuran-2-one type compound is of formula XV 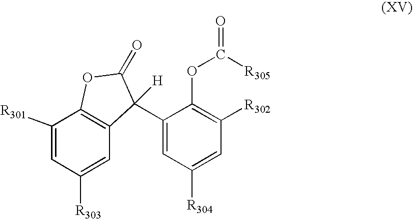
wherein
R₃₀₁ and R₃₀₂ are each independently of one another hydrogen or C₁-C₈alkyl,
R₃₀₃ and R₃₀₄ are each independently of one another C₁-C₁₂alkyl[[,]] and
R₃₀₅ is C₁-C₇alkyl.

14. A process according to claim 1 wherein the bis-acyllactam is used in an amount of 0.01 to 5 % by weight based on the weight of the polycondensate.

15. A process according to claim I wherein the phosphite, phosphinate or phosphonate is used in an amount of 0.01 to 5 % by weight based on the weight of the polycondensate.

16. A process according to claim 1 wherein the benzofuran-2-one type compound is used in an amount of 0.01 to 5 % by weight based on the weight of the polycondensate.

17. A process according to claim 1 wherein the ratio of the bis-acyllactam to b1) the phosphite, phosphinate or phosphonate or to b2) the benzofuran-2-one type compound or to b3) the sum of all is from 1:10 to 5:1.

18. A process according to claim 1 wherein the maximum mass-temperature of the melt is from 170° to 320° C.

19. A process according to claim 1 wherein an oxazoline compound is additionally present.

20. A composition comprising
a) a polycondensate;
b) at least one bis-acyllactam and
c1) at least one phosphite, phosphinate or phosphonate; or
c2) at least one benzofuran-2-one type compound or
c3) at least one phosphite, phosphinate or phosphonate and one benzofuran-2-one type compound.

21. A polycondensate obtained by a process according to clam 1.

22. (canceled)
